(19) United States
(12) Patent Application Publication
(10) Pub. No.: US 2010/0070336 A1
(43) Pub. Date: Mar. 18, 2010

(54) Providing Customer Relationship Management Application as Enterprise Services

(75) Inventors: Alexander Koegler, Walldorf (DE); Hamid Moghaddam, Osterburken (DE); Christian Haas, Heidelberg (DE); Berthold Wocher, Gaiberg (DE); Steffen Hartig, Nussloch (DE); Joachim Barnbeck, Heidelberg (DE); Olivier M. Dreidemy, Holving (FR); Alexandra Mark, Wiesloch (DE); Michael Lesk, Ketsch (DE); Andre Wachholz-Prill, Bellheim (DE); Martina Lahr, Weinheim (DE); Joerg Walzenbach, Uberherrn (DE); Helge Schulte, St. Ingbert (DE); Volkmar Stegmann, Altlussheim (DE); Ingo Pfitzner, Berlin (DE); Christoph Engler, Walldorf (DE); Wilfried Merkel, Heidelberg (DE); Thomas Bach, Muehlhausen (DE); Cordula Ude, Muehlhausen (DE); Peer Marschall, Heidelberg (DE); Stefan Adelmann, Mannheim (DE); Rainer Heun, Reilingen (DE); Katja Kasteleiner, Mannheim (DE); Martina Keller, Niefern (DE); Andrea Sudbrack, Heidelberg (DE); Anoop Kulkarni, Bangalore (IN); Ralph Meiswinkel, Bad Schoenborn (DE); Peter Marx, Tholey (DE); Simon Dieterich, Heidelberg (DE); Matthias Schwarz, Mannheim (DE); Bernhard May, Merzig (DE)

Correspondence Address: FISH & RICHARDSON, P.C., PO BOX 1022, MINNEAPOLIS, MN, 55440-1022, US

(73) Assignee: SAP AG

(21) Appl. No.: 12/233,479

(22) Filed: Sep. 18, 2008

(51) Int. Cl. G06Q 10/00

(52) U.S. Cl. 705/10

(57) ABSTRACT

Methods and apparatus, including systems and computer program products, for a services architecture design that provides enterprise services having customer relationship management functionality at the level of an enterprise application. The design includes a set of service operations, process components, and optionally deployment units. Suitable business objects are also described.

### BACKGROUND

This specification relates to data processing systems implemented on computers, and more particular to data processing systems providing services in the nature of web services.

Enterprise software systems are generally large and complex. Such systems can require many different components, distributed across many different hardware platforms, possibly in several different geographical locations. Thus, the architecture of a large software application, i.e., what its components are and how they fit together, is an important aspect of its design for a successful implementation.

Web services are one technology for making the functionality of software applications available to other software, including other applications. A web service is a standards-based way of encapsulating the functionality of an application that other applications can locate and access. A service-oriented architecture is a distributed software model within which functionality is defined as independent web services. Within a service-oriented architecture, web services can be used in defined sequences according to business logic to form applications that enable business processes.

### SUMMARY

This specification describes a services architecture design that provides enterprise services having customer relationship management functionality at the level of an enterprise application. Enterprise services are web services that have an enterprise-level business value.

In its various aspects, the invention can be embodied in systems, methods, and computer program products. For example, a system in one embodiment implements a services architecture design that provides enterprise services having customer relationship management functionality at the level of an enterprise application. The design includes a set of service operations, process components, and optionally deployment units. Suitable business objects are also described.

The subject matter described in this specification can be implemented to realize one or more of the following advantages. Effective use is made of process components as units of software reuse, to provide a design that can be implemented reliably in a cost effective way. Effective use is made of deployment units, each of which is deployable on a separate computer hardware platform independent of every other deployment unit, to provide a scalable design. Service interfaces of the process components define a pair-wise interaction between pairs of process components that are in different deployment units in a scalable way.

Details of one or more implementations of the subject matter described in this specification are set forth in the accompanying drawings and in the description below. Further features, aspects, and advantages of the subject matter will become apparent from the description, the drawings, and the claims.

### BRIEF DESCRIPTION OF THE DRAWINGS

FIGS. 1A, 1B, 1C, and 1D collectively illustrate a high-level view of a software architectural design and implementation of a suite of enterprise software services having customer relationship management functionality.

FIGS. 2A, 2B, 2C, 2D, and 2E are block diagrams collectively showing a customer invoice processing process component.

FIG. 3 is a block diagram showing an opportunity processing process component.

FIGS. 4A and 4B are block diagrams collectively showing a service confirmation processing process component.

FIGS. 5A and 5B are block diagrams collectively showing a service order processing process component.

FIGS. 6A, 6B, and 6C are block diagrams collectively showing a service request processing process component.

FIG. 7 is a block diagram showing a customer return processing process component.

FIGS. 8A, 8B, and 8C are block diagrams collectively showing an activity management process component.

FIGS. 9A, 9B, 9C, and 9D are block diagrams collectively showing a sales order processing process component.

FIGS. 10A and 10B are block diagram collectively showing a customer quote processing process component.

FIG. 11 is a block diagram of a lead processing process component.

FIGS. 12A and 12B are block diagrams collectively showing a price master data management process component.

FIGS. 13A and 13B are block diagrams collectively showing a support request processing process component.

FIG. 14 is a block diagram showing a customer invoice processing component.

FIG. 15 is a block diagram showing a customer problem and solution administration process component.

FIG. 16 is a block diagram showing a customer relationship auxiliaries processing process component.

FIGS. 17A, 17B, and 17C are block diagram collectively showing a customer complaint processing process component.

FIG. 18 is a block diagram showing a pricing engine process component.

Like reference numbers and designations in the various drawings indicate like elements.

### DETAILED DESCRIPTION

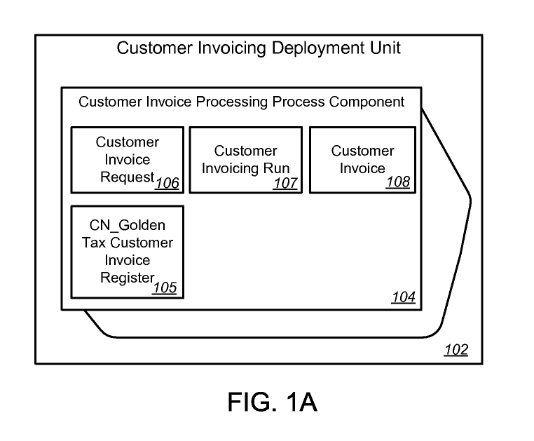

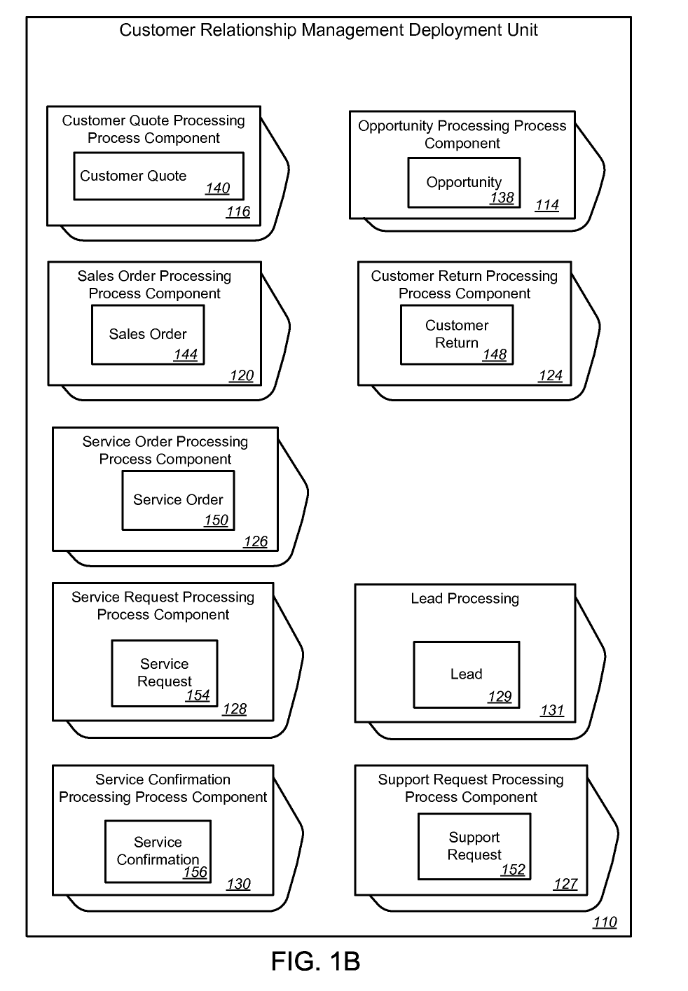

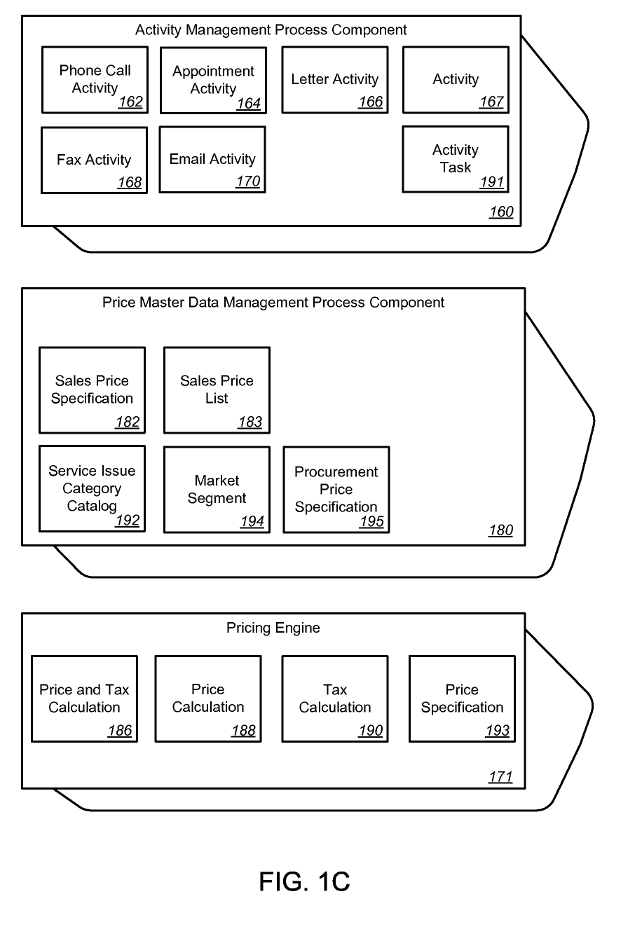

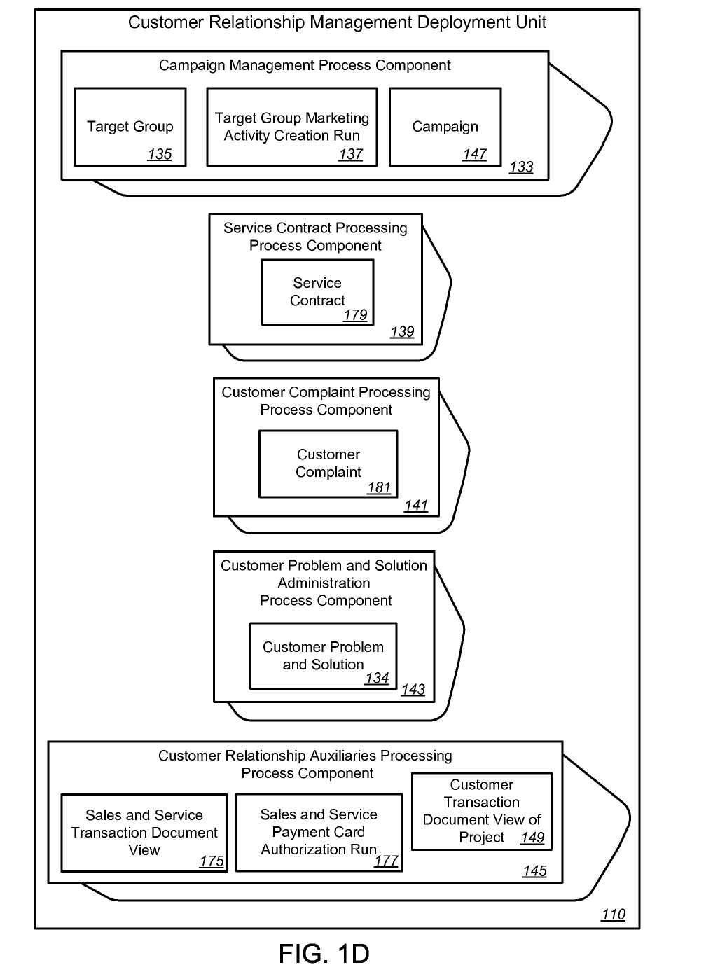

FIGS. 1A, 1B, 1C, and 1D collectively illustrate a high-level view of a software architectural design, and of application software implementations of the design, that provides a suite of enterprise service operations, which can be organized into interfaces, having customer relationship management application functionality. The software corresponding to FIGS. 1A and 1B in some implementations is for deployment in an application layer of an application server, while the software corresponding to FIG. 1C is for deployment in a foundation layer, which will be described below.

The elements of the architecture include the business object, the process component, the service operation (or simply, the operation), the service interface, the message, and the deployment unit. The elements can also include process agents and reuse service components. These will be generally described below.

In some implementations, the software is implemented to be deployed on an application platform that includes a foundation layer that contains all fundamental entities that can used from multiple deployment units. These entities can be process components, business objects or reuse service components. A reuse service component is a piece of software that is reused in different transactions. A reuse service component is used by its defined interfaces, which can be, e.g., local APIs (Application Programming Interfaces) or service interfaces.

The architectural design is a specification of a computer software application, and elements of the architectural design can be implemented to realize a software application that implements enterprise application service interfaces. The elements of the architecture are at times described in this specification as being contained or included in other elements; for example, a process component is described as being contained in a deployment unit. It should be understood, however, that such operational inclusion can be realized in a variety of ways and is not limited to a physical inclusion of the entirety of one element in another.

The architectural elements include the business object. A business object is a representation of a type of a uniquely identifiable business entity (an object instance) described by a structural model. Processes operate on business objects.

A business object represents a specific view on some well-defined business content. A business object represents content, and instances of business objects include content, which a typical business user would expect and understand with little explanation. Whether an object as a type or an instance of an object is intended by the term “object” is generally clear from the context, so the distinction will be made explicitly only when necessary. Also, for convenience and brevity, an object instance may be described in this specification as being or including a real world event, activity, item, or the like; however, such description should be understood as stating that the object instance represents (i.e., contains data representing) the respective event, activity, item, or the like. Properly implemented, business objects are implemented free of redundancies.

Business objects are further categorized as business process objects, master data objects, mass data run objects, dependent objects, and transformed objects. A master data object is an object that encapsulates master data (i.e., data that is valid for a period of time). A business process object, which is the kind of business object generally found in a process component, is an object that encapsulates transactional data (i.e., data that is valid for a point in time). A mass data run object is an application object that executes an algorithm for a particular mass data run. An instance of a mass data run object embodies or contains a particular set of selections and parameters. A mass data run object implements an algorithm that modifies, manages, and/or processes a large amount of data in multiple transactions, possibly but not necessarily with parallel processing. A dependent object is a business object used as a reuse part in another business object. A dependent object represents a concept that cannot stand by itself from a business point of view. Instances of dependent objects only occur in the context of a non-dependent business object. A transformed object is a transformation of multiple business objects for a well-defined purpose. It transforms the structure of multiple business objects into a common structure. A transformed object does not have its own persistency.

The architectural elements also include the process component. A process component is a software package that realizes a business process and generally exposes its functionality as services. The functionality includes the ability to perform all or parts of particular kinds of business transactions. A process component contains one or more semantically related business objects. Any business object belongs to no more than one process component.

Process components are modular and context-independent. That they are context-independent means that a process component is not specific to any specific application and is reusable. The process component is the smallest (most granular) element of reuse in the architecture.

The architectural elements also include the operation. An operation belongs to exactly one process component. A process component generally has multiple operations. Operations can be synchronous or asynchronous, corresponding to synchronous or asynchronous process agents, which will be described below. An operation is the smallest, separately-callable function, described by a set of data types used as input, output, and fault parameters, or some combination of them, serving as a signature. For convenience in supporting use of the operations supported by a system implementing elements of the design, such a system can optionally include a repository of service descriptions that includes a standards-based description of each of the supported service operations.

The architectural elements also optionally include the service interface, which may be referred to simply as an interface. An interface is a named group of operations. Each operation belongs to exactly one interface. An interface belongs to exactly one process component. A process component might implement multiple interfaces. In some implementations, an interface will have only inbound or outbound operations, but not a mixture of both. One interface can include both synchronous and asynchronous operations. All operations of the same type (either inbound or outbound) which belong to the same message choreography will preferably belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. An operation can use multiple message types for inbound, outbound, or error messages. When two process components are in different deployment units, invocation of an operation of one process component by the other process component is accomplished by an operation on the other process component sending a message to the first process component.

The architectural elements also include the process agent. Process agents do business processing that involves the sending or receiving of messages. Each operation will generally have at least one associated process agent. A process agent can be associated with one or more operations. Process agents can be either inbound or outbound, and either synchronous or asynchronous.

Asynchronous outbound process agents are called after a business object changes, e.g., after a create, update, or delete of a business object instance.

Synchronous outbound process agents are generally triggered directly by a business object.

An outbound process agent will generally perform some processing of the data of the business object instance whose change triggered the agent or caused the agent to be called. An outbound agent triggers subsequent business process steps by sending messages using well-defined outbound services to another process component, which generally will be in another deployment unit, or to an external system. An outbound process agent is linked to the one business object that triggers the agent, but it is sent not to another business object but rather to another process component. Thus, the outbound process agent can be implemented without knowledge of the exact business object design of the recipient process component.

Inbound process agents are called after a message has been received. Inbound process agents are used for the inbound part of a message-based communication. An inbound process agent starts the execution of the business process step requested in a message by creating or updating one or multiple business object instances. An inbound process agent is not the agent of a business object but of its process component. An inbound process agent can act on multiple business objects in a process component.

Synchronous agents are used when a process component requires a more or less immediate response from another process component, and is waiting for that response to continue its work.

Operations and process components are described in this specification in terms of process agents. However, in alternative implementations, process components and operations can be implemented without use of agents using other conventional techniques to perform the functions described in this specification.

The architectural elements also include the deployment unit. A deployment unit includes one or more process components and, optionally, one or more business objects, that are deployed together on a single computer system platform. Conversely, separate deployment units can be deployed on separate physical computing systems. For this reason, a deployment unit boundary defines the limits of an application-defined transaction, i.e., a set of actions that have the ACID properties of atomicity, consistency, isolation, and durability. To make use of database manager facilities, the architecture requires that all operations of such a transaction be performed on one physical database; as a consequence, the processes of such a transaction must be performed by the process components of one instance of one deployment unit.

The process components of one deployment unit interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by a deployment unit to be scaled to meet demand by creating as many instances as needed.

Since interaction between deployment units is through service operations, a deployment unit can be replaced by other another deployment unit as long as the new deployment unit supports the operations depended upon by other deployment units. Thus, while deployment units can depend on the external interfaces of process components in other deployment units, deployment units are not dependent on process component interactions (i.e., interactions between process components involving their respective business objects, operations, interfaces, and messages) within other deployment units. Similarly, process components that interact with other process components or external systems only through messages, e.g., as sent and received by operations, can also be replaced as long as the replacement supports the operations of the original.

Interactions between process components that occur only within a deployment unit are not constrained to using service operations. These can be implemented in any convenient fashion.

In contrast to a deployment unit, the foundation layer does not define a limit for application-defined transactions. Deployment units communicate directly with entities in the foundation layer, which communication is typically not message based. The foundation layer is active in every system instance on which the application is deployed. Business objects in the foundation layer will generally be master data objects. In addition, the foundation layer will include some business process objects that are used by multiple deployment units. Master data objects and business process objects that should be specific to a deployment unit are preferably assigned to their respective deployment unit.

FIGS. 1A, 1B, 1C, and 1D collectively illustrate a high-level view of a software architectural design and implementation of a suite of enterprise software services having customer relationship management functionality.

As shown in FIG. 1A, a Customer Invoicing deployment unit 102 includes a Customer Invoice Processing process component 104. The Customer Invoice Processing process component 104 handles customer invoicing for the delivery of goods or the provision of services. The Customer Invoice Processing process component 104 includes a Customer Invoice Request business object 106, a Customer Invoicing Run business object 107, a Customer Invoice business object 108, and a CN Golden Tax Customer Invoice Register business object 105. The Customer Invoice Request business object 106 represents a request to create one or several customer invoices, or to take account of the data for the underlying business document when creating a customer invoice. The Customer Invoicing Run business object 107 represents a specification of an automated run that creates customer invoices based on customer invoice requests. The Customer Invoice business object 108 represents a binding statement of amounts receivable resulting, for example, from deliveries to a customer, services performed for a customer, adjustments to these receivables, or credit memos to a customer. The CN Golden Tax Customer Invoice Register business object 105 represents a register of customer invoices of a company that require data transfer to an external Golden Tax system.

As shown in FIG. 1B, a Customer Relationship Management deployment unit 110 includes an Opportunity Processing process component 114, a Customer Quote Processing process component 116, a Sales Order Processing process component 120 a Customer Return Processing process component 124, a Service Order Processing process component 126, a Support Request Processing process component 127, a Service Request Processing process component 128, a Service Confirmation Processing process component 130, and a Lead Processing process component 131.

The Opportunity Processing process component 114 includes an Opportunity business object 138. The Customer Quote Processing process component 116 includes a Customer Quote business object 140. The Sales Order Processing process component 120 includes a Sales Order business object 144. The Customer Return Processing process component 124 includes a Customer Return business object 148. The Service Order Processing process component 126 includes a Service Order business object 150. The Support Request Processing process component 127 includes a Support Request business object 152. The Service Request Processing process component 128 includes a Service Request business object 154. The Service Confirmation Processing process component 130 includes a Service Confirmation business object 156. The Lead Processing process component 131 includes a Lead business object 129 that includes potential or projected business interests of a business partner and the interactions based on this, over a period of time.

As shown in FIG. 1C, an Activity Management process component 160, a Price Master Data Management process component 180 and a Pricing Engine process component 171 located in the foundation layer can also be included in the architectural elements. The Activity Management process component 160 can be used to record all activities, such as, business activities and tasks, undertaken on behalf of the company. The Price Master Data Management process component 180 manages prices and price-related data for sales and procurement processes. The Pricing Engine process component 171 processes price and tax calculations.

The Activity Management process component 160 includes a Phone Call Activity business object 162, an Appointment Activity business object 164, a Letter Activity business object 166, an Activity business object 167, a Fax Activity business object 168, an Email Activity business object 170, a Task master data object 172, and an Activity Task business object 191.The Phone Call Activity business object 162 records telephone interactions that are undertaken by employees on behalf of their company. The Appointment Activity business object 164 includes different types of planned activities that are maintained in an employee's calendar, including external appointments and scheduled meetings with other business parties. The Letter Activity business object 166 records messages written on paper by employees on behalf of their company. The Activity business object 167 provides a general structured view of activities of carious types in order to plan and document interactions related to business partners. The Fax Activity business object 168 records documents or graphics transmitted over a telecommunications facility by employees on behalf of their company. The Email Activity business object 170 records communication between employees on behalf of their company via the Internet. The Activity Task business object 191 represents a task used in Activity Management containing information about anything an employee needs to do within a certain time frame, and which can be related to a business partner.

The Price Master Data Management process component 180 includes a Sales Price Specification business object 182, a Sale Price List business object 183, a Service Issue Category Catalog business object 192, a Market Segment business object 194, and a Procurement Price Specification business object 195. The Sales Price Specification business object 182 is a specification of a price, a discount, or a surcharge that is used indirectly for pricing in sales and service documents. The specification is defined for a combination of properties and is valid for a specific period. The Sales Price List business object 183 is a list of price specifications with respect to common identifying criteria. The Service Issue Category Catalog business object 192 represents a structured directory of issue categories that describe business transactions in customer service from an objective or subjective point of view. The Market Segment 194 business object represents a sector of the overall market that is characterized by a specific constellation of supply and demand and that exhibits specific customer and product characteristics as well as characteristics for regional and organizational classification. The Procurement Price Specification business object 195 represents the specification of a price, a discount, or a surcharge for procurement of goods or services. The specification can be defined for a combination of property values and can be valid for a specific period.

The Pricing Engine process component 171 includes a Price and Tax Calculation business object 186, a Price Calculation business object 188, a Tax Calculation business object 190, and a Price Specification business object 193. The Price and Tax Calculation business object 186 represents a combination of determined price and tax elements for a business transaction. The Price Calculation business object 188 represents a combination of the determined price elements for the business transaction. The Tax Calculation business object 190 represents a summarization of the determined and calculated tax elements of a business case. The Price Specification business object 193 represents a specification of a price, a discount, or a surcharge for sales, service, and purchasing. The specification can be defined for a combination of properties and can be valid for a specific period.

As shown in FIG. 1D, the Customer Relationship Management deployment unit 110 also includes a Campaign Management process component 133, a Service Contract Processing process component 139, a Customer Complaint Processing process component 141, a Customer Problem and Solution Administration process component 143, and a Customer Relationship Auxiliaries Processing process component 145. The Campaign Management process component 133 can define the process of customer segmentation, multi-channel marketing campaign development and execution including response handling and result tracking. The Service Contract Processing process component 139 handles the maintenance of contractual agreements that are concluded between service providers and customers for specific time periods. They can serve as a basis for processing service requests and service orders in a customer service and support environment. In service contracts it is possible to specify the type and scope of services that are provided to the customer, as well as particular service levels. The agreements that have been made in the service contract can be invoiced to the customer. Revenues from the contract and costs incurred from services delivered with reference to the contract can be collected in financial accounting. The Customer Complaint Processing process component 141 can include the administration and maintenance of customer complaint data. The Customer Problem and Solution Administration process component 143 can include the administration and maintenance of customer problem and solution master data that has, for example, been migrated or replicated from an external system. The Customer Relationship Auxiliaries Processing process component 143 can include the processing of supporting functionality valid for multiple process components in the Customer Relationship Management deployment unit.

The Campaign Management process component 133 includes a Target Group business object 135, a Target Group Marketing Activity Creation Run business object 137, and a Campaign business object 147. The Target Group business object 135 represents a group of customers, prospects, or contact persons to be contacted by means of marketing activities. The Target Group Marketing Activity Creation Run business object 137 represents a specification for an automated run that creates personalized mails or other marketing related activities addressed to the members of a selected target group.

The Service Contract Processing process component 139 includes a Service Contract business object 179 which represents an agreement between a service provider and a customer, specifying the type and scope of services that are provided to the customer, as well as particular service levels. The agreement can be valid for a specific time period.

The Customer Complaint Processing process component 141 includes a Customer Complaint business object 181 which represents a recorded objection by a customer, typically related to an experience the customer has had with a seller or a service provider.

The Customer Problem and Solution Administration process component 143 includes a Customer Problem and Solution business object 134 which represents a collection consisting of one or several problems reported by a customer, and one or several solutions provided by one or more experts.

The Customer Relationship Auxiliaries Processing process component 145 includes a Sales and Service Transaction Document View business object 175, a Sales and Service Payment Card Authorization Run business object 177, and a Customer Transaction Document View of Project business object 149. The Sales and Service Transaction Document View business object 175 represents a view of common information from several sales and service transaction documents. The Sales and Service Payment Card Authorization Run business object 177 represents specification of an automated run that authorizes the payment amount on a payment card and also reauthorizes expired authorizations by replacing them with new ones based on sales orders or service orders.

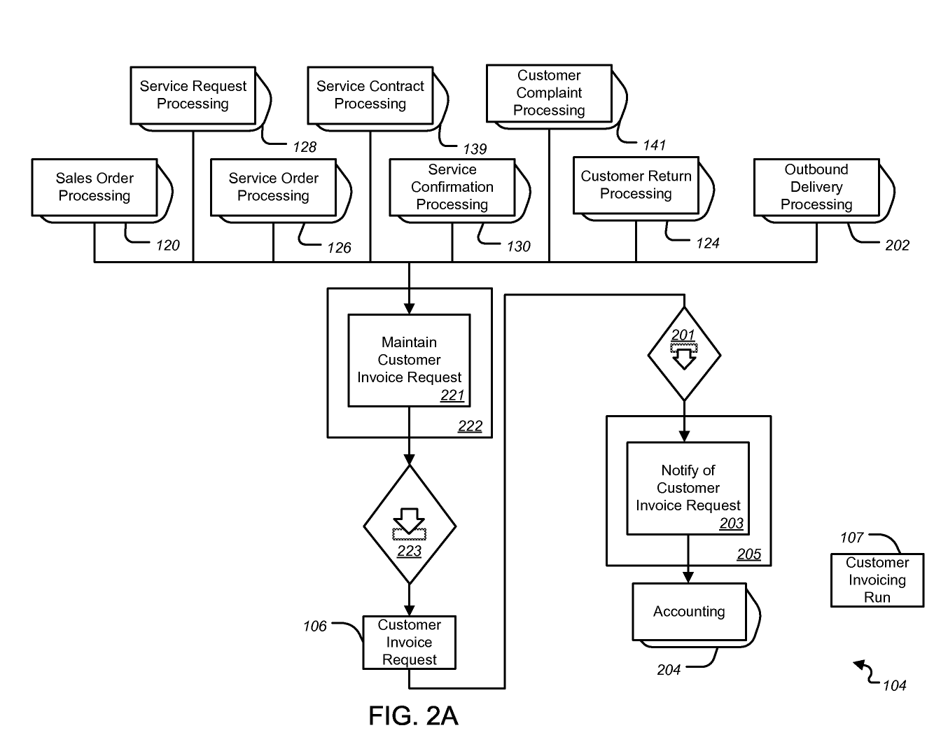

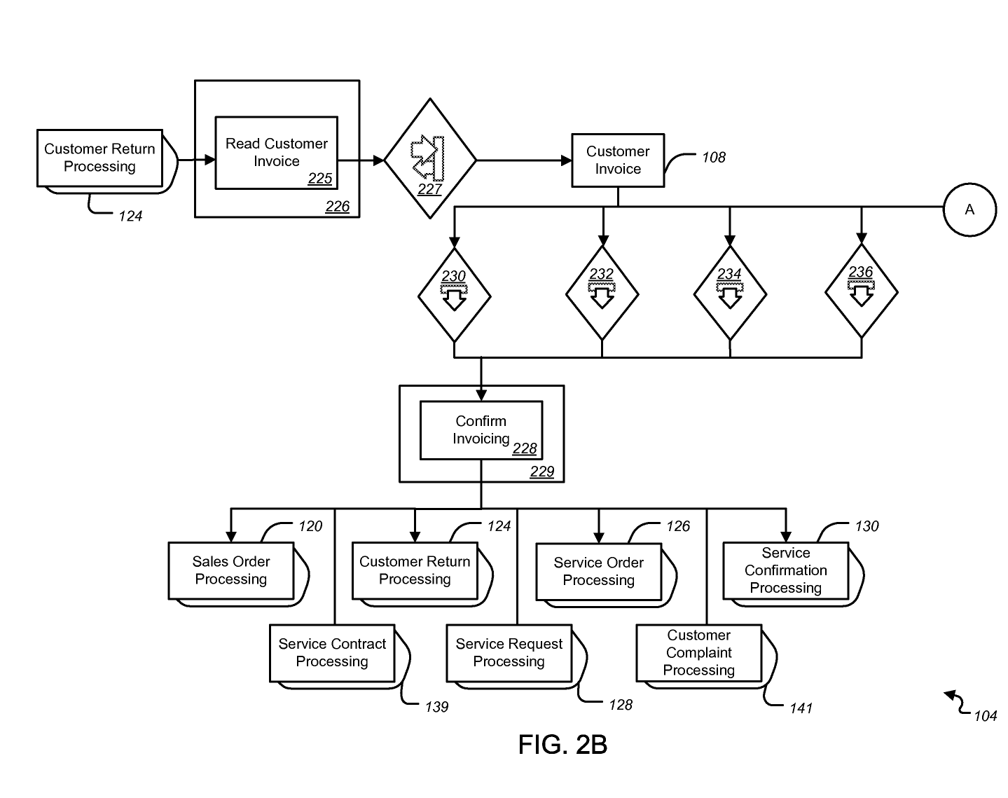

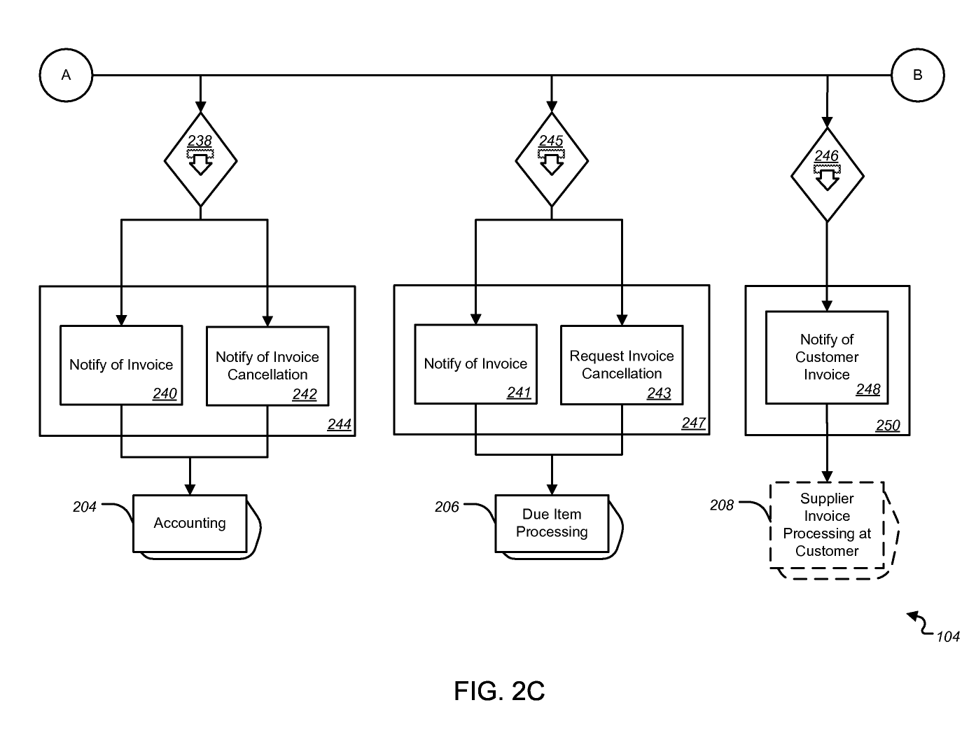

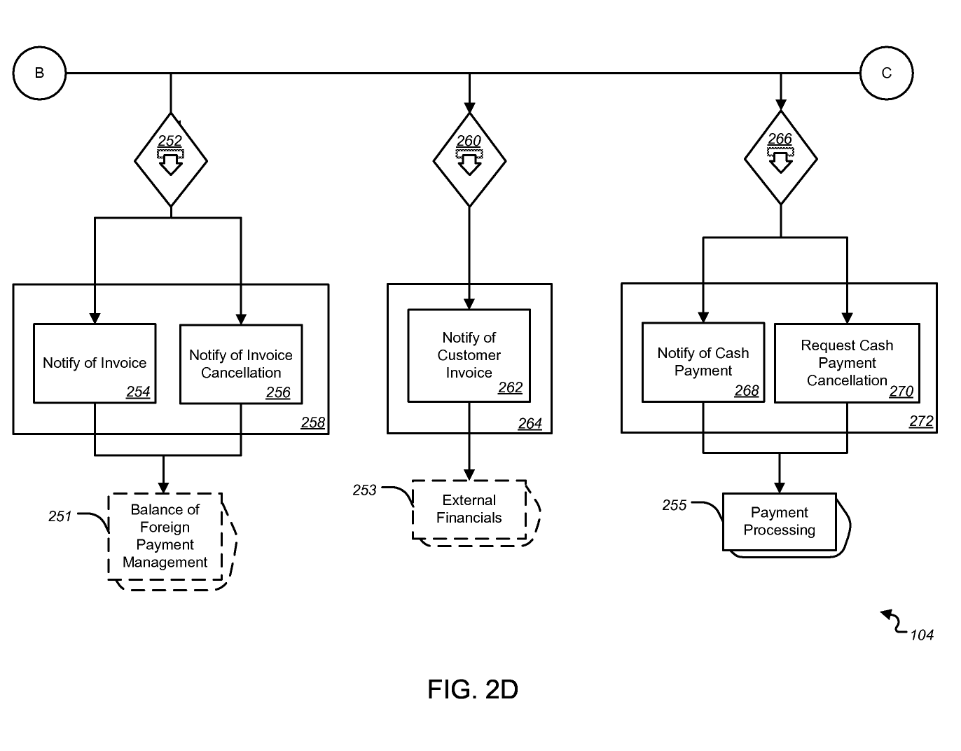

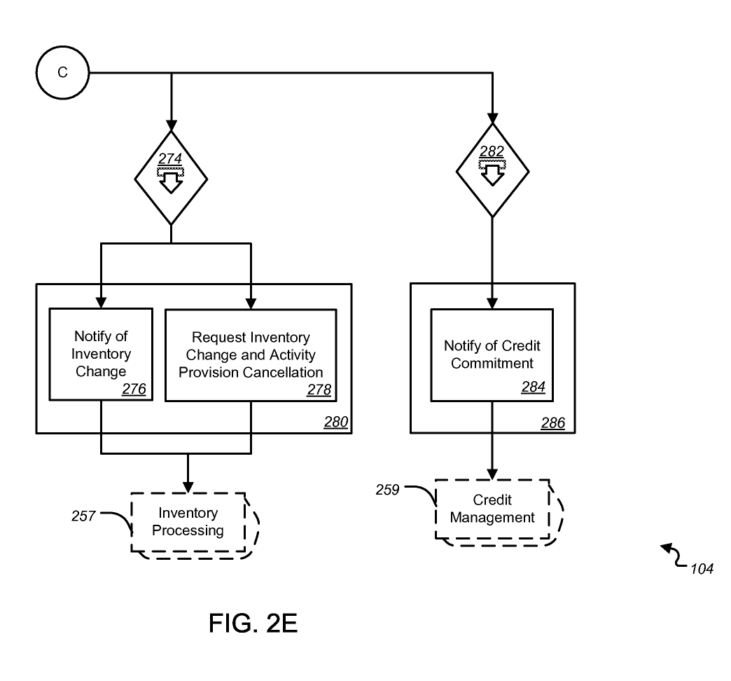

FIGS. 2A, 2B, 2C, 2D and 2E are block diagrams collectively showing the Customer Invoice Processing process component 104 (FIG. 1A). For convenience in describing this process component, a number of other process components are shown in the figures; these other process components are not part of the process component 104. These other process components are the Sales Order Processing process component 120, the Service Request Processing process component 128, the Service Contract Processing process component 139, the Customer Complaint Processing process component 141, the Customer Return Processing process component 124, the Service Order Processing process component 126, the Service Confirmation Processing process component 130, an Outbound Delivery Processing process component 202, an Accounting process component 204, a Due Item Processing process component 206, and a Supplier Invoice Processing at Customer process component 208. These other process components are used to represent software external to the process component in describing its interactions with the external software; however, while the external software can be implemented as such process components, this is not required.

The Outbound Delivery Processing process component 202 handles the management and processing of the outbound delivery requirements for shipping goods to a product recipient. It combines all document-based tasks for the outbound delivery process, and enables communication with an originating document (fulfillment), the product recipient and invoicing. The Accounting process component 204 manages the representation of all relevant business transactions for valuation and profitability analysis. The Due Item Processing process component 206 manages the collection, management, and monitoring of trade receivables or payables and corresponding sales tax or withholding tax. The Supplier Invoice Processing at Customer process component 208 is drawn with dashed lines to indicate that it is used to represent an external system in describing interactions with the external system; this should be understood to require no more of the external system than that it be able to produce and receive messages as required by the process component that interacts with the external system.

As shown in FIG. 2A, a Maintain Customer Invoice Request operation 221 is included in a Request Invoicing In interface 222. The Maintain Customer Invoice Request operation 221 creates, updates, deletes or requests cancellation of a customer invoice request. The operation 221 uses a Maintain Customer Invoice Request asynchronous outbound process agent 223 to update the Customer Invoice Request business object 106.

The Customer Invoicing Run business object 107 can also receive an update in the Customer Invoicing Processing process component 104. The Customer Invoicing Run business object 107 represents a specification for how automatically to create customer invoices from customer invoice requests. The Customer Invoicing Run business object 107 can also log the specification processes.

Upon receiving the update, the Customer Invoice business object 108 can use a synchronous Notify of Customer Invoice Request to Accounting outbound process agent 201 to invoke a Notify of Customer Invoice Request operation 203. The operation 203 is included in a Sales and Purchasing Accounting Notification Out interface 205 and can send an update to the Accounting process component 204.

As shown in FIG. 2B, once a customer invoice request has been provided, the Customer Return Processing process component 124 can send a message to the Customer Invoicing Processing process component 104, which is handled by a Read Customer Invoice operation 225 to provide information about the customer invoice. The Read Customer Invoice operation 225 is included in a Manage Customer Invoice In interface 226. The Read Customer Invoice operation 225 can send an update to the Customer Invoice business object 108 using a Read Customer Invoice inbound process agent 227.

Upon receiving the update, the Customer Invoice business object 108 can use various asynchronous outbound process agents to invoke a Confirm Invoicing operation 228. The operation 228 confirms that a customer invoice was created (or cancelled) to process components which requested invoicing. The Confirm Invoicing operation 228 is included in a Request Invoicing Out interface 229. The Customer Invoice business object 108 can use a particular process agent depending on the process component requesting the update. For example, if the Sales Order Processing process component 120 requests an update, a Confirm Customer Invoice to Sales Order Processing outbound process agent 230 can be used to invoke the Confirm Invoicing operation 228. Similarly, if the Customer Return Processing process component 124 requests an update, a Confirm Customer Invoice to Customer Return Processing outbound process agent 232 can be used to invoke the Confirm Invoicing operation 228. In turn, if the Service Order Processing process component 126 requests an update, a Confirm Customer Invoice to Service Order Processing outbound process agent 234 can be used to invoke the Confirm Invoicing operation 228. Finally, if the Service Confirmation Processing process component 130 requests an update, a Confirm Customer Invoice to Service Confirmation Processing outbound process agent 236 can be used to invoke the Confirm Invoicing operation 228. The Confirm Invoicing operation 228 can also update the Service Request Processing process component 128, the Service Contract Processing process component 139, and the Customer Complaint Processing process component 141. The Customer Invoice business object 108 can also invoke several operations that will be discussed in the description for FIG. 2C.

As shown in FIG. 2C, the Customer Invoice business object 108 can use a Notify of Customer Invoice to Accounting asynchronous outbound process agent 238 to invoke a Notify of Invoice operation 240 or a Notify of Invoice Cancellation operation 242. The Notify of Invoice operation 240 and the Notify of Invoice Cancellation operation 242 are included in an Invoice Accounting Out interface 244 and can send an update to the Accounting process component 204. The Notify of Invoice operation 240 informs accounting about outgoing invoices or credit memos. The Notify of Invoice Cancellation operation 242 informs accounting about cancellation of invoices or credit memos.

The Customer Invoice business object 108 can also use a Notify of Customer Invoice to Due Item Processing asynchronous outbound process agent 245 to invoke the Notify of Invoice operation 241 or the Notify of Invoice Cancellation operation 243. The operations 241 and 243 are included in a receivables Payables Out interface 247. The operations 241 and 243 can update the Due Item Processing process component 206.

The Customer Invoice business object 108 can further use a Notify Customer of Customer Invoice asynchronous outbound process agent 246 to invoke a Notify Customer of Invoice operation 248. The Notify Customer of Invoice operation 248 is included in an Invoicing Out interface 250. The operation 248 can update a Supplier Invoice Processing at Customer process component 208.

As shown in FIG. 2D, the Customer Invoice business object 108 can use a Notify of Customer Invoice to Balance of Foreign Payments Management asynchronous outbound process agent 252 to invoke a Notify of Invoice operation 254 or a Notify of Invoice Cancellation operation 256. The Notify of Invoice operation 254 and the Notify of Invoice Cancellation operation 256 are included in an Invoicing Out interface 258 and can send an update to a Balance of Foreign Payment Management process component 251. The Notify of Invoice operation 254 informs accounting about outgoing invoices or credit memos. The Notify of Invoice Cancellation operation 256 informs accounting about cancellation of invoices or credit memos.

The Customer Invoice business object 108 can also use a Notify of Customer Invoice to External Financials asynchronous outbound process agent 260 to invoke the Notify of Invoice operation 262. The operation 262 is included in a Cash Payment Out interface 264. The operation 262 can update the External Financials process component 253.

The Customer Invoice business object 108 can further use a Notify of Cash Payment from Customer Invoice to Payment Processing asynchronous outbound process agent 266 to invoke a Notify of Cash Payment operation 268 or a Request Cash Payment Cancellation operation 270. The operations 268, 270 are included in a Cash Payment Out interface 272. The operations 268, 270 can update a Payment Processing process component 255.

As shown in FIG. 2E, the Customer Invoice business object 108 can use a Notify of Goods Withdrawal from Customer Invoice to Inventory Processing asynchronous outbound process agent 274 to invoke a Notify of Inventory Change operation 276 or a Request Inventory Change and Activity Provision Cancellation operation 278. The operations 276 and 278 are included in a Cash Payment Out interface 280 and can send an update to an Inventory processing process component 257.

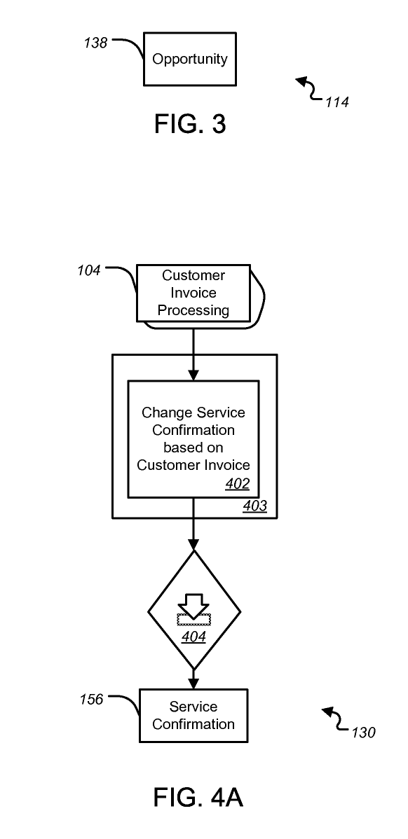

The Customer Invoice business object 108 can also use a Customer Invoice to Credit Management asynchronous outbound process agent 282 to invoke the Notify of Credit Commitment operation 284. The operation 284 is included in a Credit Usage Out interface 286. The operation 284 can update a Credit Management process component 259. FIG. 3 is a block diagram showing an Opportunity processing process component 114. The Opportunity Processing process component 114 handles development, processing, and monitoring of opportunities with the aim to initiate sales and service details. The Opportunity Processing process component 114 includes an Opportunity business object 138 that represents a recognized possibility for sales of products or services. An opportunity can result from a trade fair, a sales deal, or a bid invitation. The Opportunity business object 138 summarizes a variety of business information, such as the expected sales revenue or expected net value.

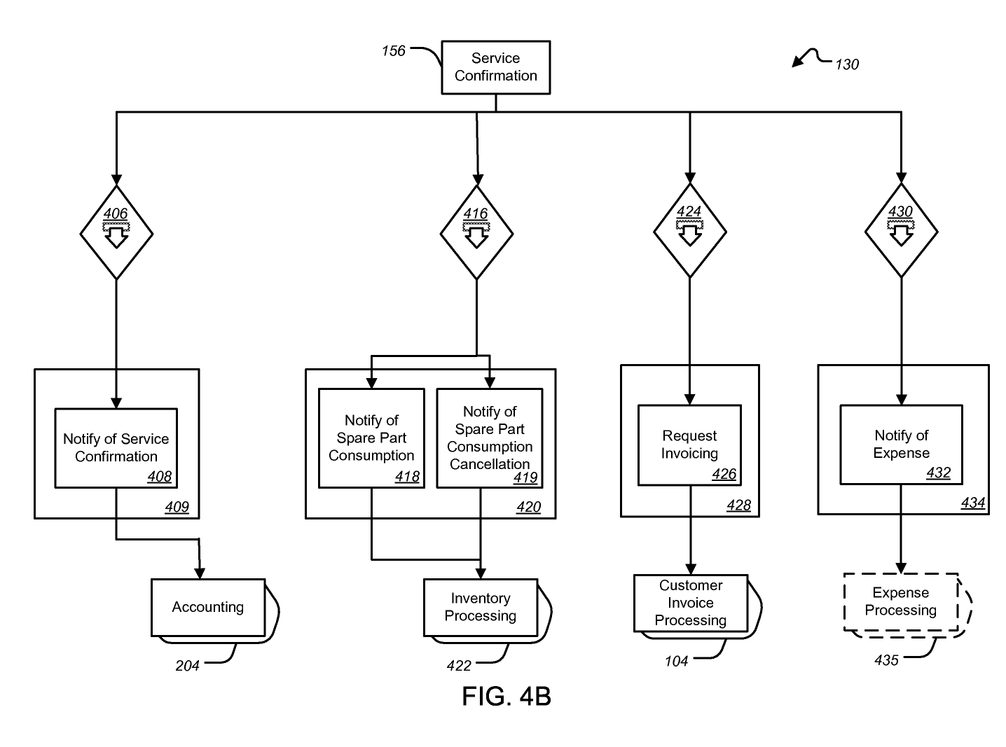

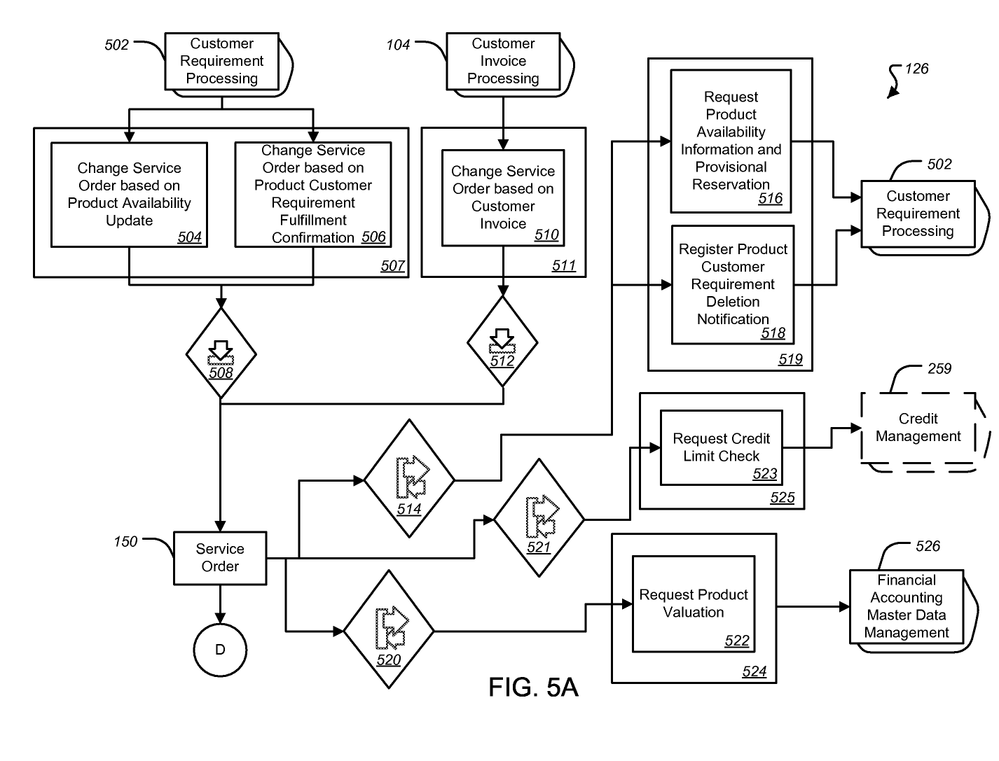

FIGS. 4A and 4B are block diagrams collectively showing a Service Confirmation Processing process component 130. For convenience in describing this process component, a number of other process components are shown in the figures; these other process components are not part of the process component 130. These other process components are the Customer Invoice Processing process component 104, the Accounting process component 204, and the Inventory Processing process component 422. The Inventory Processing process component 422 provides for the management of inventory and recording of inventory changes. It provides services to maintain current stock, content and structure of logistic units and allocations. These other process components are used to represent software external to the process component 130 in describing its interactions with the external software; however, while the external software can be implemented as such process components, this is not required.

As shown in FIG. 4A, the Customer Invoice Processing process component 104 can invoke a Change Service Confirmation based on Customer Invoice operation 402. The Change Service Confirmation based on Customer Invoice operation 402 is included in a Request Invoicing In interface 403. The operation 402 updates a service confirmation in order to document information about issued customer invoices in the service confirmation. The Change Service Confirmation based on Customer Invoice operation 402 can send an update to the Service Confirmation business object 156 using a Change Service Confirmation based on Customer Invoice asynchronous inbound process agent 404.

As shown in FIG. 4B, the Service Confirmation business object 156 can update several process components through various interfaces and operations. As such, a Notify of Service Confirmation to Accounting asynchronous outbound process agent 406 can invoke a Notify of Service Confirmation operation 408 to notify the Accounting process component 204 about the creation, change, or deletion of a service confirmation. The Notify of Service Confirmation operation 408 is included in an Order Accounting Out interface 409.

The Service Confirmation business object 156 can also use a Notify of Spare Part Consumption from Service Confirmation to Inventory Processing asynchronous outbound process agent 416 to invoke a Notify of Spare Part Consumption operation 418. The Notify of Spare Part Consumption operation 418 is included in an Inventory Changing Out interface 420. The Notify of Spare Part Consumption operation 418 can notify the Inventory Processing process component 422 about actual consumption of spare parts.

The Service Confirmation business object 156 can also use a Request Invoicing from Service Confirmation to Customer Invoice Processing asynchronous outbound process agent 424 to invoke a Request Invoicing operation 426. The Request Invoicing operation 426 is included in a Request Invoicing Out interface 428 and requests invoicing of services provided and spare parts consumed as reported back in the service confirmation as actual values. An update can then be sent to the Customer Invoice Processing process component 104.

The Service Confirmation business object 156 can also use a Notify of Expense from Service Confirmation to Expense Processing asynchronous outbound process agent 430 to invoke a Notify of Expense operation 432. The operation 432 is included in a Request Expensing Out interface 434 and requests invoicing of services provided and spare parts consumed as reported back in the service confirmation as actual values. An update can then be sent to the Expense Processing process component 435.

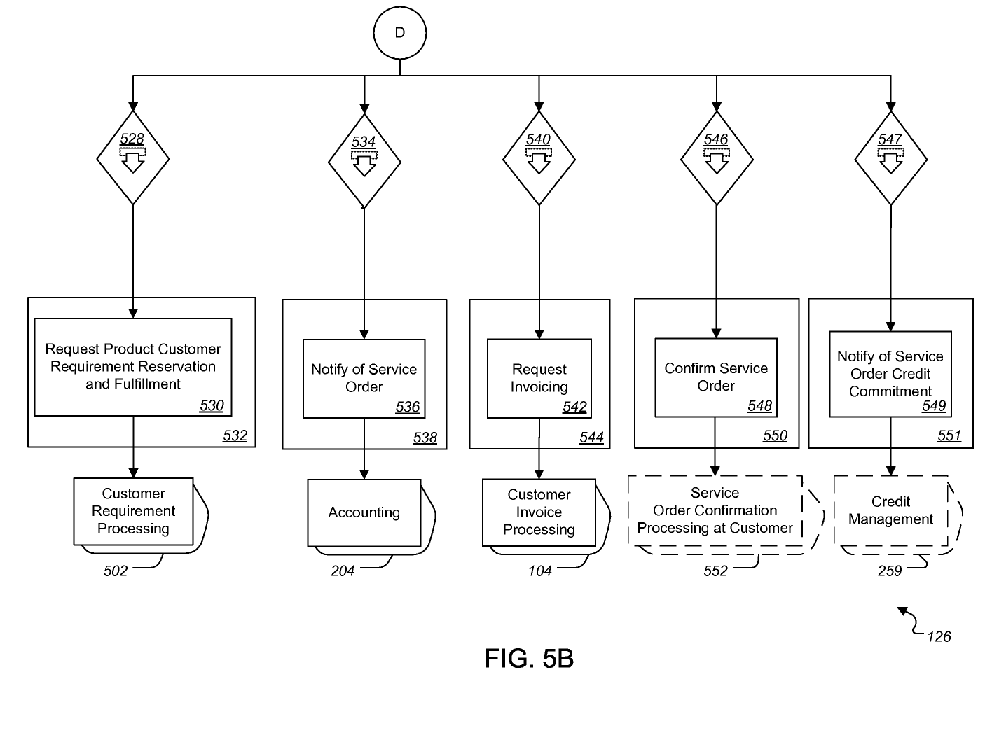

FIGS. 5A and 5B are block diagrams collectively showing a Service Order Processing process component 126. The Service Order Processing process component 126 handles the reporting back of actual times and quantities for services provided, and spare parts consumed related to the execution of a service order. For convenience in describing this process component, a number of other process components are shown in the figures; these other process components are not part of the process component 126. These other process components include the Customer Invoice Processing process component 104, the Accounting process component 204, a Customer Requirement Processing process component 502, a Financial Accounting Master Data Management process component 526, and a Service Order Confirmation Processing at Customer process component 552. The Customer Requirement Processing process component 502 handles the controlling of customer requirements in the supply chain. This involves checking material availability, receiving, preparing, and passing customer requirements on to supply planning and logistics, and providing feedback on fulfillment. The Financial Accounting Master Data Management process component 526 manages financial accounting master data that is used both for accounting and costing purposes. These other process components are used to represent software external to the process component 126 in describing its interactions with the external software; however, while the external software can be implemented as such process components, this is not required.

As shown in FIG. 5A, the Customer Requirement Processing process component 502 can send a message to invoke a Change Service Order based on Product Availability Update operation 504 or a Change Service Order based on Product Customer Requirement Fulfillment Confirmation operation 506. The Change Service Order based on Product Availability Update operation 504 updates service orders with spare part availability and reservation information based on customer requirement fulfillment planning data. The Change Service Order based on Product Customer Requirement Fulfillment Confirmation operation 506 updates service orders with spare part quantity delivered to a customer or picked up by a service technician. Both operations 504, 506 are included in a Fulfillment In interface 507. Upon receiving the update or confirmation, a Change Service Order based on Customer Requirement asynchronous inbound process agent 508 can send an update to the Service Order business object 150.

The Customer Invoice Processing process component 104 can send a message to invoke a Change Service Order based on Customer Invoice operation 510. The Change Service Order based on Customer Invoice operation 510 documents information about issued customer invoices in the service order. The Change Service Order based on Customer Invoice operation 510 is included in a Request Invoicing In interface 511. A Change Service Order based on Customer Invoice asynchronous inbound process agent 512 can send an update to the Service Order business object 150.

After receiving an update, the Service Order business object 150 can use a synchronous Request Availability Information and Reservation from Service Order to Customer Requirement process agent 514 to invoke a Request Product Availability Information and Provisional Reservation operation 516. The process agent 514 can also invoke a Register Product Customer Requirement Deletion Notification operation 518. The operation 516 requests availability information including the creation of a provisional reservation for service order spare part items. The operation 518 registers a provisional spare part requirement reservation for deletion and triggers deletion in case of failure or cancellation of transaction processing. Both operations 516, 518 are included in a Fulfillment Out interface 519 and can update the Customer Requirement Processing process component 502.

The Service Order business object 150 can also use a synchronous Request Product Valuation from Service Order to Financial Accounting Master Data asynchronous outbound process agent 520 to invoke a Request Product Valuation operation 522. The Request Product Valuation operation 522 requests a product valuation. The operation 522 is included in a Product and Resource Valuation Out interface 524. The operation 522 can update the Financial Accounting Master Data Management process component 526.

The Service Order business object 150 can also use a synchronous Request Credit Limit Check from Service Order to Credit Management asynchronous outbound process agent 521 to invoke a Request Credit Limit Check operation 523. The operation 523 can request a credit limit for an account. The operation 523 is included in a Credit Limit Out interface 525. The operation 523 can update the Credit Management process component 259.

As shown in FIG. 5B, the Service Order business object 150 can use a Request Requirement Reservation and Fulfillment from Service Order to Customer Requirement asynchronous outbound process agent 528 to invoke a Request Product Customer Requirement Reservation and Fulfillment operation 530. The Request Product Customer Requirement Reservation and Fulfillment operation 530 requests reservation and fulfillment for customer requirements (e.g., a sales order). The Request Product Customer Requirement Reservation and Fulfillment operation 530 is included in a Fulfillment Out interface 532 and can send an update to the Customer Requirement Processing process component 502.

The Service Order business object 150 can also use a Notify of Service Order to Accounting asynchronous outbound process agent 534 to invoke a Notify of Service Order operation 536. The Notify of Service Order operation 536 notifies the Accounting process component 204 about the creation, change, or deletion of a service order. The Notify of Service Order operation 536 is included in a Sales and Purchasing Accounting Out interface 538.

The Service Order business object 150 can also use a Request Invoicing from Service Order to Customer Invoice Processing asynchronous outbound process agent 540 to invoke a Request Invoicing operation 542. The Request Invoicing operation 542 is included in a Request Invoicing Out interface 544 and can update the Customer Invoice Processing process component 104.

The Service Order business object 150 can also use a Confirm Service Order to Customer asynchronous outbound process agent 546 to invoke a Confirm Service Order operation 548. The Confirm Service Order operation 548 confirms a service order to a customer. The Confirm Service Order operation 548 is included in an Ordering Out interface 550. The Confirm Service Order operation 548 can update the Service Order Confirmation Processing at Customer process component 552. This process component 552 is drawn with dashed lines to indicate that it is used to represent an external system in describing interactions with the external system; this should be understood to require no more of the external system than that it be able to produce and receive messages as required by the process component that interacts with the external system.

The Service Order business object 150 can also use a Notify of Service Order Credit Commitment from Service Order to Credit Management asynchronous outbound process agent 547 to invoke a Notify of Service Order Credit Commitment operation 549. The operation 549 can make the notification of a credit commitment for a service order. The operation 549 is included in a Credit Commitment Out interface 551. The operation 549 can update the Credit Management process component 259. This process component 259 is drawn with dashed lines to indicate that it is used to represent an external system in describing interactions with the external system; this should be understood to require no more of the external system than that it be able to produce and receive messages as required by the process component that interacts with the external system.

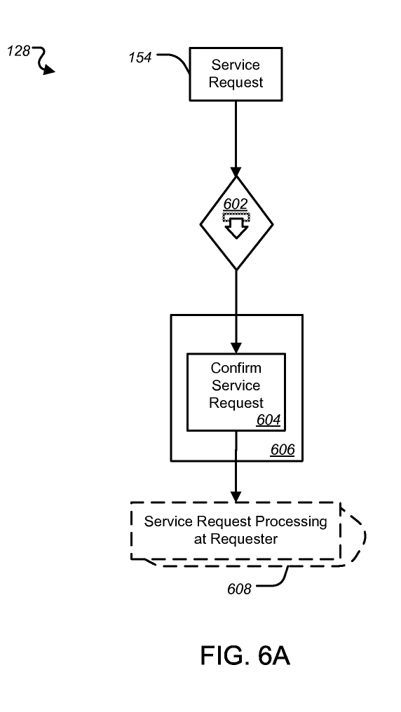

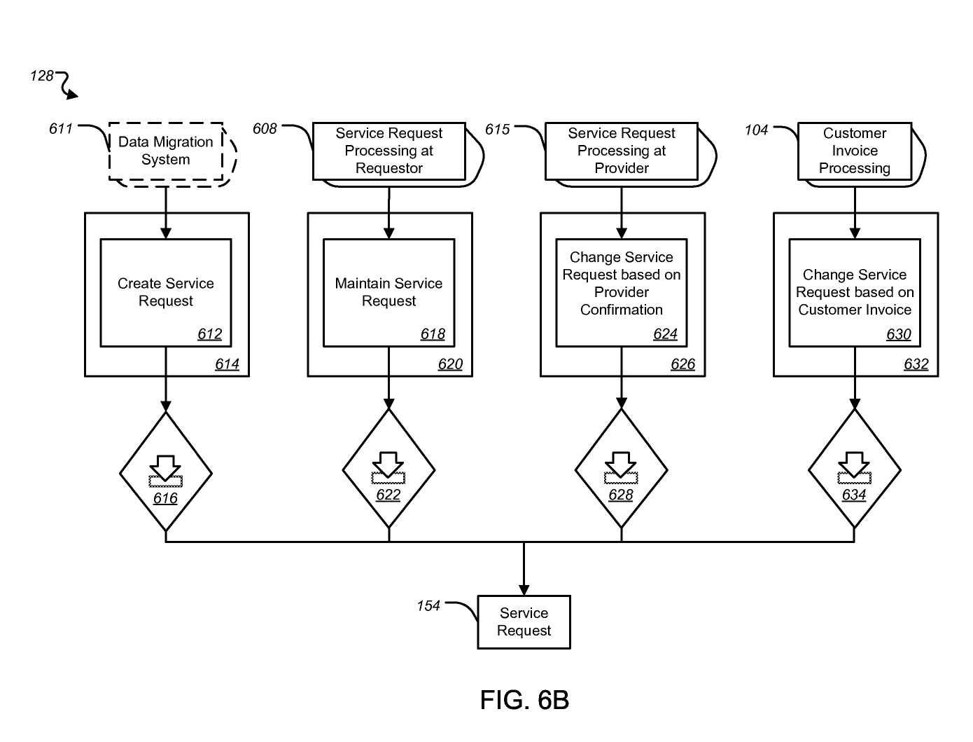

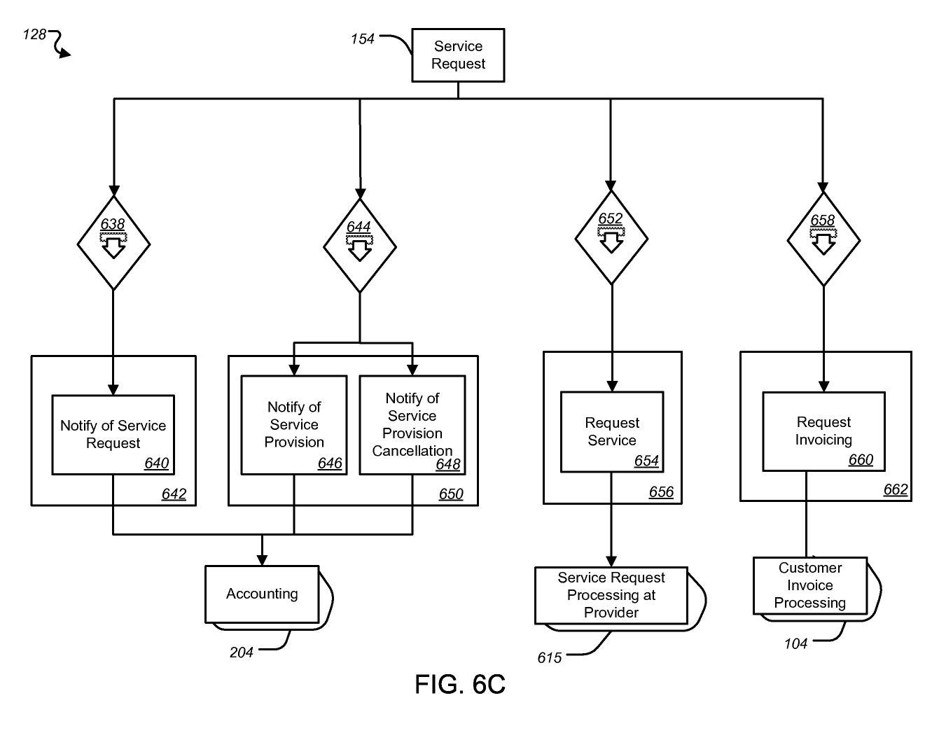

FIGS. 6A, 6B and 6C are block diagrams collectively showing a Service Request Processing process component 128. The Service Request Processing process component 128 handles logging and resolving service requests concerning issues that customers can have with regard to products.

As shown in FIG. 6A, the Service Request business object 154 can use a Confirm Service Request from Service Request Processing to Requester asynchronous outbound process agent 602 to invoke a Confirm Service Request operation 604. The Confirm Service Request operation 604 sends creation information, update information, or processing information to a service requestor. The Confirm Service Request operation 604 is included in an External Providing Out interface 606. The operation 604 can update a Service Request Processing at Requester process component 608. This process component is drawn with dashed lines to indicate that it is used to represent an external system in describing interactions with the external system; this should be understood to require no more of the external system than that it be able to produce and receive messages as required by the process component that interacts with the external system.

As shown in FIG. 6B, the Data Migration System process component 611 can send a message to invoke a Create Service Request operation 612. The operation 612 creates a service request based on data coming from another system. The operation 612 is included in a Migration In interface 614. The operation 612 can use a Create Service Request based on Migration asynchronous inbound process agent 616 to update the Service Order business object 150.

The Service Request Processing at Requestor process component 608 can send a message to invoke a Maintain Service Request operation 618. The operation 618 maintains a service request based on information from the customer. The operation 618 is included in an External Providing In interface 620. The operation 618 can use a Maintain Service Request asynchronous inbound process agent 622 to update the Service Order business object 150.

A Service Request Processing at Provider process component 615 can send a message to invoke a Change Service Request based on Provider Confirmation operation 624. The operation 624 updates a service request based on information from the provider. The operation 624 is included in an External Requesting In interface 626. The operation 624 can use a Change Service Request based on Provider Confirmation asynchronous inbound process agent 628 to update the Service Order business object 150.

The Customer Invoice Processing process component 104 can send a message to invoke a Change Service Request based on Customer Invoice operation 630. The operation 630 updates a service request based on information from the related customer invoices. The operation 630 is included in a Request Invoicing In interface 632. The operation 630 can use a Change Service Request based on Customer Invoice asynchronous inbound process agent 634 to update the Service Order business object 150.

As shown in FIG. 6C, the Service Request business object 154 can use a Notify of Service Request to Accounting asynchronous outbound process agent 638 to invoke a Notify of Service Request operation 640. The operation 640 notifies Accounting that a service request has been processed. The operation 640 is included in a Sales and Purchasing Accounting Out interface 642. The operation 640 can update the Accounting process component 204.

The Service Request business object 154 can use a Notify of Service Provision from Service Request to Accounting asynchronous outbound process agent 644 to invoke a Notify of Service Provision operation 646 or a Notify of Service Provision Cancellation operation 648. The operation 646 notifies Accounting of the actual service provided and the time involved. The operation 648 notifies Accounting that a confirmation of a service provided has been cancelled. The operations 646, 648 are included in a Service Provision Accounting Out interface 650. The operations 646, 648 can update the Accounting process component 204.

The Service Request business object 154 can use a Request Service from Service Request to Provider asynchronous outbound process agent 652 to invoke a Request Service operation 654. The operation 654 requests assistance from an external provider. The operation 654 is included in an External Requesting Out interface 656. The operation 656 can update the Service Request Processing at Provider process component 615.

The Service Request business object 154 can use a Request Invoicing From Service Request to Customer Invoice Processing asynchronous outbound process agent 658 to invoke a Request Invoicing operation 660. The operation 660 requests invoicing of a service request. The operation 660 is included in a Request Invoicing Out interface 662. The operation 660 can update the Customer Invoice Processing process component 104.

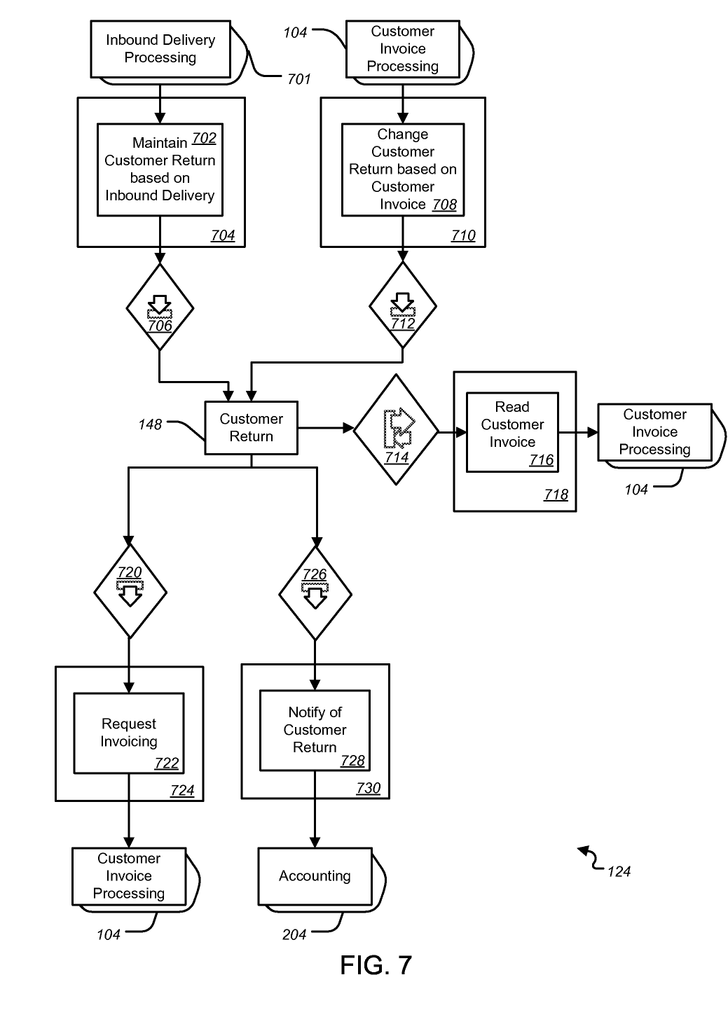

FIG. 7 is a block diagram showing a Customer Return Processing process component 124. The Customer Return Processing process component 124 processes requests made by customers to sellers to take back goods that were delivered (e.g., to reverse a sale). For convenience in describing this process component 124, a number of other process components are shown in the figures; these other process components are not part of the process component 124. These other process components are the Customer Invoice Processing process component 104, the Accounting process component 204, and an Inbound Delivery Processing process component 701. The Inbound Delivery Processing process component 701 handles the management and processing of the inbound delivery requirements for received goods from a vendor. It combines all document-based tasks for the inbound delivery process, and enables communication with the originating document (fulfillment), the vendor and invoicing. These other process components are used to represent software external to the process component 124 in describing its interactions with the external software; however, while the external software can be implemented as such process components, this is not required.

Processing for the Customer Return Processing process component 124 can begin in the Inbound Delivery Processing process component 701 or the Customer Invoice Processing process component 104. The Inbound Delivery Processing process component 701 can send a message to the Customer Return Processing process component 124, which is handled by a Maintain Customer Return based on Inbound Delivery operation 702 to create or change a customer return based on information form inbound delivery and confirmed inbound delivery. The operation 702 is included in a Request Customer Return Execution In interface. The operation 702 can use a Maintain Customer Return based on Inbound Delivery asynchronous inbound process agent to update the Customer Return business object 148.

Similarly, the Customer Invoice Processing process component 104 can provide an update to the Customer Return Processing process component 124. The Customer Invoice Processing process component 104 can include details about a customer return in a message to the Customer Return Processing process component 124, which is handled by a Change Customer Return based on Customer Invoice operation 708. The Change Customer Return based on Customer Invoice operation 708 is included in a Request Invoicing In interface 710. The operation 708 can use a Change Customer Return based on Customer Invoice asynchronous outbound process agent 712 to update the Customer Return business object 148.

The Customer Return business object 148 can invoke an update for several other process components about the customer return. For example, the Customer Return business object 148 can use a synchronous Read Customer Invoice from Customer Return to Customer Invoice outbound process agent 714 to invoke a Request Customer Invoice operation 716. The operation 716 requests information about customer invoice in case there is a customer invoice as the reference of the customer return. The operation 716 is included in a Manage Customer Invoice Out interface 718. The Request Customer Invoice operation 716 can update the Customer Invoice Processing process component 104 regarding the customer return.

The Customer Return business object 148 can use a Request Invoicing from Customer Return to Customer Invoice Processing asynchronous outbound process agent 720 to invoke a Request Invoicing operation 722. The Request Invoicing operation 722 requests invoicing of a customer return. This can invoke the creation of a credit note in the Customer Invoice Processing process component 104. The Request Invoicing operation 722 is included in a Request Invoicing Out interface 724. The operation 722 can update the Customer Invoice Processing process component 104 regarding the customer return.

The Customer Return business object 148 can also use a Notify of Customer Return to Accounting asynchronous outbound process agent 726 to invoke a Notify of Customer Return operation 728. The Notify of Customer Return operation 728 notifies the Accounting process component 204 about the creation, change, or cancellation of a customer return. The Notify of Customer Return operation 728 is included in a Sales and Purchasing Accounting Out interface 730. The operation 728 can update the Accounting process component 204 regarding the customer return.

The Customer Return business object 148 can also use a Synchronous Read Customer Invoice from Customer Return to Customer Invoice outbound process agent 714 to invoke a Request Customer Invoice operation 716. The Read Customer Invoice operation 716 requests information about a customer invoice in case there is a customer invoice as the reference of the customer return. The Read Customer Invoice operation 716 is included in a Manage Customer Invoice Out interface 718. The operation 716 can update the Customer Invoice Processing process component 104.

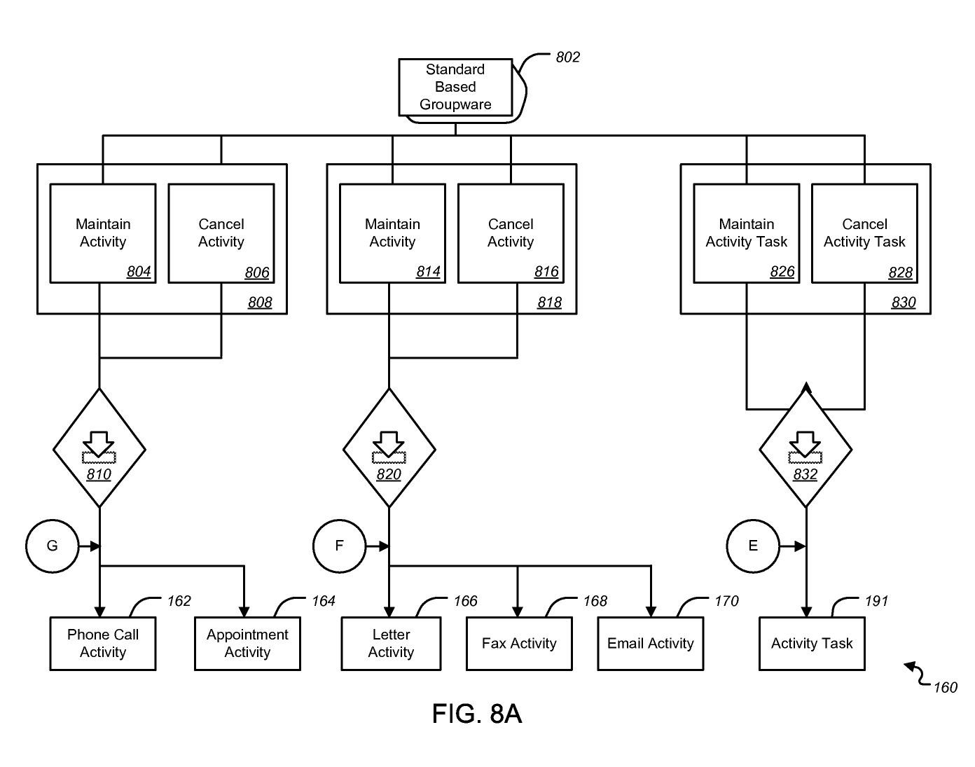

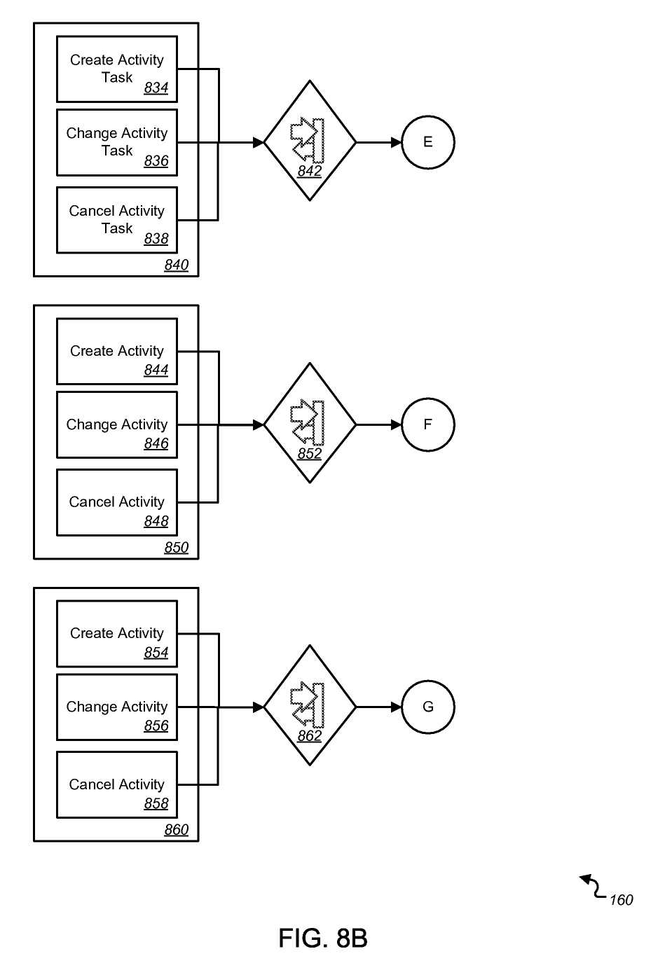

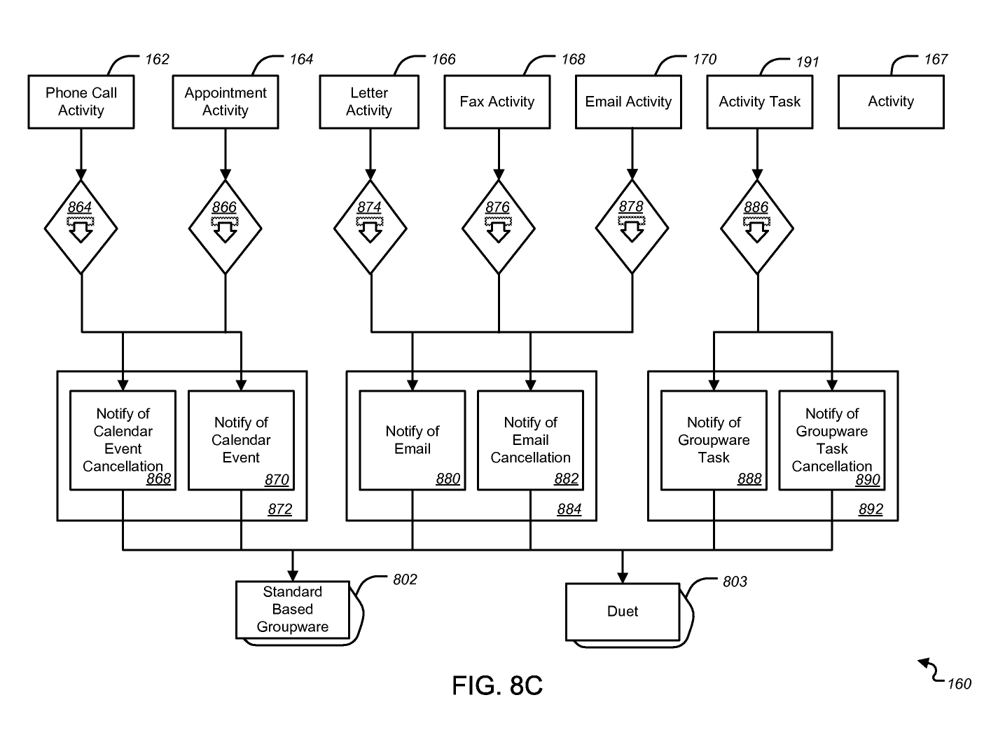

FIGS. 8A, 8B and 8C are block diagrams collectively showing an Activity Management process component 160. The Activity Management process component 160 can be used to record public interactions, that is, business activities or tasks undertaken on behalf of a particular company. The Activity Management process can begin with receiving information from a Standard Based Groupware process component 802. The Standard Based Groupware process component 802 is included in the foundation layer and is not part of a specific deployment unit.

As shown in FIG. 8A, a Standard Based Groupware process component 802 can invoke a Maintain Activity operation 804 or a Cancel Activity operation 806. The operation 804 requests to update a phone call activity or an appointment activity. The operation 804 requests to cancel a phone call activity or an appointment activity. The operations 804, 806 are included in a Calendar Event Notification In interface 808. The operations 804, 806 can use a Maintain Activity based on Calendar Event Transmission In asynchronous inbound process agent 810 to update the Phone Call Activity business object 162 and/or the Appointment Activity business object 164.

The Standard Based Groupware process component 802 can invoke a Maintain Activity operation 814 or a Cancel Activity operation 816. The operation 814 requests to update a letter, fax or email activity. The operation 816 requests to cancel a letter, fax or email activity. The operations 814, 816 are included in an Email Notification In interface 818. The operations 814, 816 can use a Maintain Activity based on Email Transmission In asynchronous inbound process agent 820 to update the Letter Activity business object 166, the Fax Activity business object 168, and/or the Email Activity business object 170.

The Standard Based Groupware process component 802 can invoke a Maintain Activity Task operation 826 or a Cancel Activity Task operation 828. The operation 826 requests to update an activity task. The operation 828 requests to cancel an activity task. The operations 826, 828 are included in a Groupware Task Notification In interface 830. The operations 826, 828 can use a Maintain Activity Task based on Groupware Task Transmission in asynchronous inbound process agent 832 to update the Activity Task business object 191.

As shown in FIG. 8B, a Create Activity Task operation 834, a Change Activity Task operation 836, or a Cancel Activity Task operation 838 can use a Manage Activity Task based on Groupware Task synchronous inbound process agent 842 to update the Activity Task business object 191. The operation 834 requests to notify Activity Management about appointment activity based on synchronization with groupware data, specifically to create an activity task. The operation 836 requests to notify Activity Management about appointment activity based on synchronization with groupware data, specifically to change an activity task. The operation 838 requests to notify Activity Management about appointment activity based on synchronization with groupware data, specifically to cancel an activity task. The operations 834, 836 and 838 are included in a Manage Groupware Task In interface 840.

A Create Activity operation 844, a Change Activity operation 846, or a Cancel Activity operation 848 can use a Manage Activity based on Email synchronous inbound process agent 852 to update the Letter Activity business object 166, the Fax Activity business object 168, and/or the Email Activity business object 170. The operation 844 requests to notify Activity Management about email activity based on synchronization with groupware data, specifically to create an activity. The operation 846 requests to notify Activity Management about email activity based on synchronization with groupware data, specifically to change an activity. The operation 848 requests to notify Activity Management about email activity based on synchronization with groupware data, specifically to cancel an activity. The operations 844, 846, 848 are included in a Manage Email In interface 850.

A Create Activity operation 854, a Change Activity operation 856, and a Cancel Activity operation 858 can use a Manage Activity based on Calendar Event synchronous inbound process agent 862 to update the Phone Call Activity business object 162 and/or the Appointment Activity business object 164. The operation 854 requests to notify Activity Management about calendar event activity based on synchronization with groupware data, specifically to create an activity. The operation 856 requests to notify Activity Management about calendar event activity based on synchronization with groupware data, specifically to change an activity. The operation 858 requests to notify Activity Management about calendar event activity based on synchronization with groupware data, specifically to cancel an activity. The operations 854, 856, 858 are included in a Manage Calendar Event In interface 860.

As shown in FIG. 8C, the Phone Call Activity business object 162 can use a Notify of Phone Call Activity to Groupware asynchronous outbound process agent 864 to invoke a Notify of Calendar Event Cancellation operation 868 or a Notify of Calendar Event operation 870. The operation 868 notifies standard based groupware or DUET about phone call activity or an appointment activity cancellation. The operation 870 notifies standard based groupware or DUET about phone call activity or an appointment activity update. The operations 868, 870 are included in a Calendar Event Notification Out interface 872. The operations 868, 870 can update the Standard Based Groupware process component 802 and a Duet process component 803. The Appointment Activity business object 164 can use a Notify of Appointment Activity To Groupware asynchronous outbound process agent 866 to invoke the operations 868, 870 to update the Standard Based Groupware process component 802 and a Duet process component 803.

The Letter Activity business object 166 can use a Notify of Letter Activity to Groupware asynchronous outbound process agent 874 to invoke a Notify of Email operation 880 or a Notify of Email Cancellation operation 882. The operation 880 notifies standard based groupware or DUET about an update of letter activity, fax activity and/or email activity. The operation 882 notifies standard based groupware or DUET about the cancellation of letter activity, fax activity and/or email activity. The operations 880, 882 are included in a Email Notification Out interface 884. The operations 880, 882 can update the Standard Based Groupware process component 802 and a Duet process component 803. The Fax Activity business object 168 can use a Notify of Fax Activity to Groupware asynchronous outbound process agent 876 to invoke the operations 880, 882 to update the Standard Based Groupware process component 802 and a Duet process component 803. The Email Activity business object 170 can use a Notify of Email Activity to Groupware asynchronous outbound process agent 878 to invoke the operations 880, 882 to update the Standard Based Groupware process component 802 and a Duet process component 803.

The Activity Task business object 191 can use a Notify of Activity Task to Groupware asynchronous outbound process agent 886 to invoke a Notify of Groupware Task operation 888 or a Notify of Groupware Task Cancellation operation 890. The operation 888 notifies standard based groupware or DUET about an update of the Activity Task business object 191. The operation 890 notifies Standard Based Groupware or DUET about the cancellation of the Activity Task business object 191. The operations 888, 890 are included in a Groupware Task Notification Out interface 892. The operations 888, 890 can update the Standard Based Groupware process component 802 and a Duet process component 803.

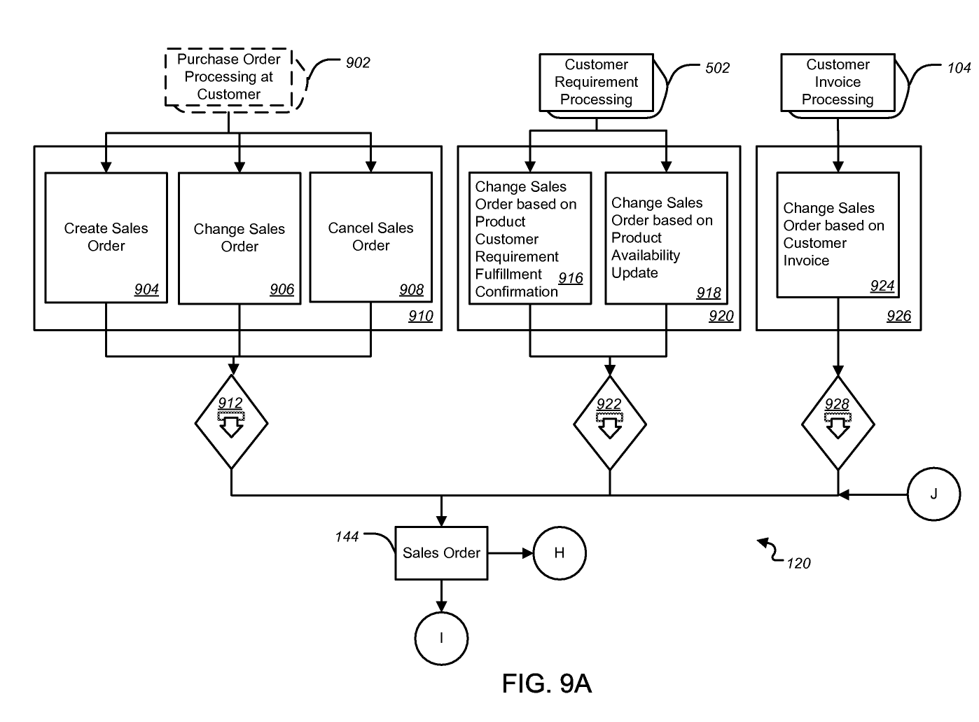

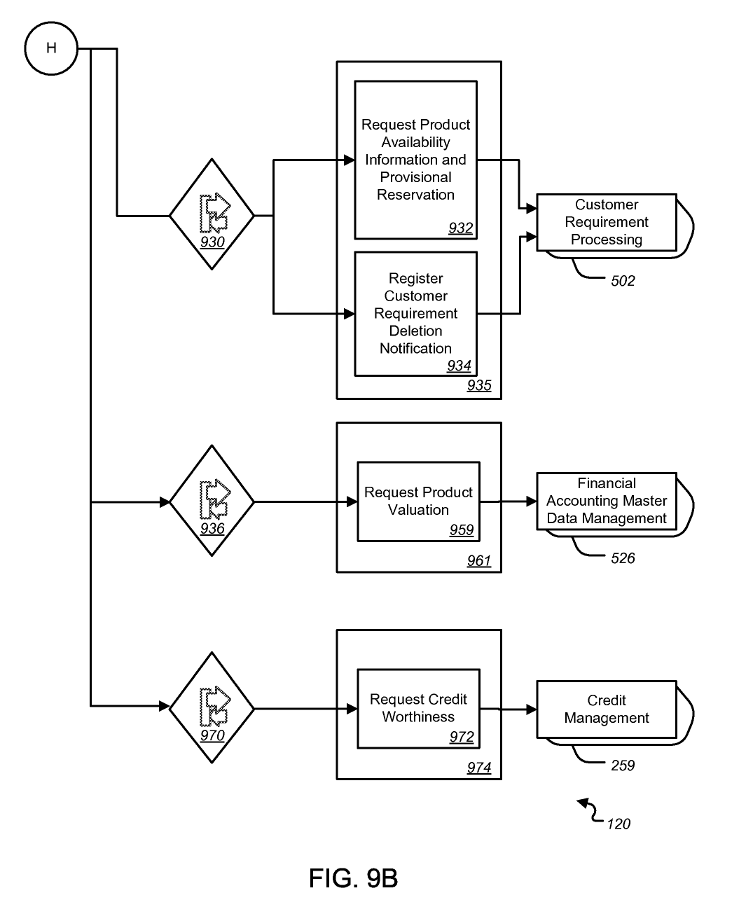

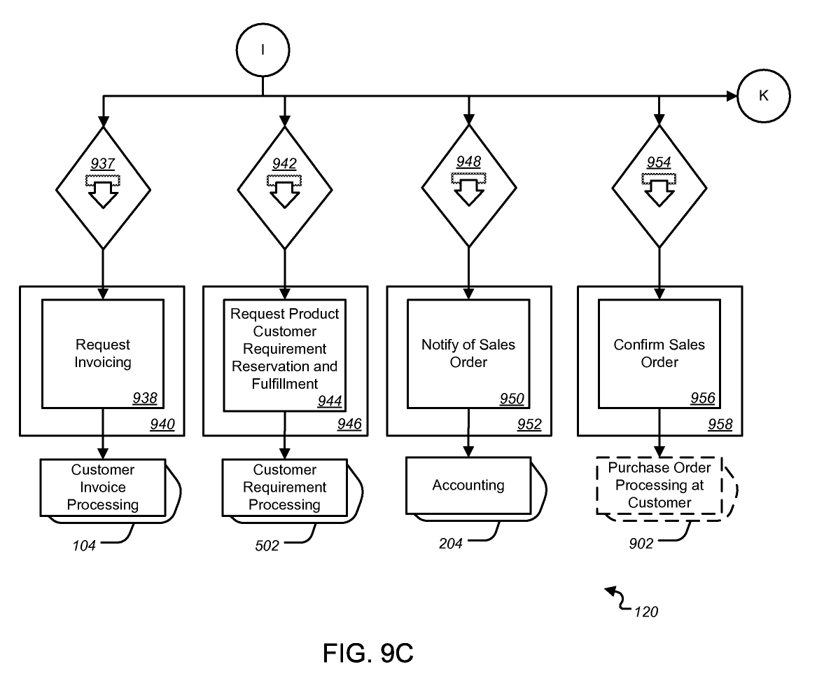

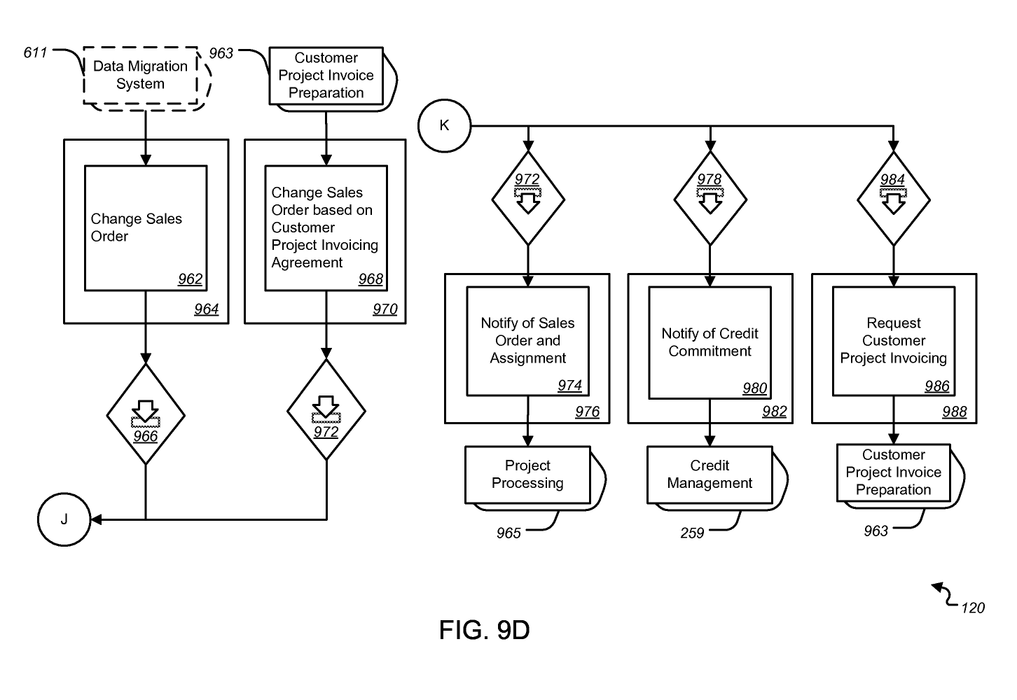

FIGS. 9A, 9B, 9C and 9D are block diagrams collectively showing a Sales Order Processing process component 120. The Sales Order Processing process component 120 handles customers' requests to a seller for the delivery of goods, on a specific date, for a specific quantity, and for a specific price. For convenience in describing this process component, a number of other process components are shown in the figures; these other process components are not part of the process component 120. These other process components are the Customer Invoice Processing process component 104, the Accounting process component 204, the Customer Requirement Processing process component 502, the Financial Accounting Master Data Management process component 526, and a Purchase Order Processing at Customer process component 902. These other process components are used to represent software external to the process component 120 in describing its interactions with the external software; however, while the external software can be implemented as such process components, this is not required. The Purchase Order Processing at Customer process component 902 is drawn with dashed lines to indicate that it is used to represent an external system in describing interactions with the external system; this should be understood to require no more of the external system than that it be able to produce and receive messages as required by the process component that interacts with the external system.

As shown in FIG. 9A, the Purchase Order Processing at Customer external process component 902 can send a message to the Sales Order Processing process component 120, which is handled by a Create Sales Order operation 904, a Change Sales Order operation 906, or a Cancel Sales Order operation 908. The Create Sales Order operation 904 creates a sales order based on a new purchase order from a customer. The Change Sales Order operation 906 changes the sales order based on changes in the purchase order from the customer. The Cancel Sales Order operation 908 cancels the sales order based on the cancellation of the purchase order from the customer. The Create Sales Order operation 904, the Change Sales Order operation 906, and the Cancel Sales Order operation 908 are included in an Ordering In interface 910. The operations 904, 906, and 908 can use a Maintain Sales Order asynchronous inbound process agent 912 to update the Sales Order business object 144.

The Customer Requirement Processing process component 502 can send a message to the Sales Order Processing process component 120, which is handled by a Change Sales Order based on Product Customer Requirement Fulfillment Confirmation operation 916 or a Change Sales Order based on Product Availability Update operation 918. The Change Sales Order based on Product Customer Requirement Fulfillment Confirmation operation 916 updates sales orders with information from fulfillment confirmation including update of status and delivered quantity information. The Change Sales Order based on Product Availability Update operation 918 changes sales orders with availability and reservation information based on changes in fulfillment planning. The Change Sales Order based on Product Customer Requirement Fulfillment Confirmation operation 916 and the Change Sales Order based on Product Availability Update operation 918 are included in a Fulfillment In interface 920. The operations 916 and 918 can use a Change Sales Order based on Customer Requirement asynchronous inbound process agent 922 to update the Sales Order business object 144.

The Customer Invoice Processing process component 104 can send a message to the Sales Order Processing process component 120, which is handled by a Change Sales Order based on Customer Invoice operation 924. The Change Sales Order based on Customer Invoice operation 924 updates sales orders with information from customer invoice including update status and invoiced quantity information. The Change Sales Order based on Customer Invoice operation 924 is included in a Request Invoicing In interface 926. The operation 924 can use a Change Sales Order based on Customer Invoice asynchronous inbound process agent 928 to update the Sales Order business object 144.

As shown in FIG. 9B, the Sales Order business object 144 can use a synchronous Request Product Availability from Sales Order to Customer Requirement outbound process agent 930 to invoke a Request Product Availability Information and Provisional Reservation operation 932 or a Register Customer Requirement Deletion Notification operation 934. The operation 932 requests product availability information including the creation of a provisional reservation for a customer requirement (i.e., a sales order). The operation 934 registers a provisional sales requirement reservation for deletion and triggers deletion in case of failure or cancellation of transaction processing. The operations 932, 934 are included in a Fulfillment Out interface 935. The operations 932, 934 can update the Customer Requirement Processing process component 502.

The Sales Order business object 144 can also use a synchronous Request Product Valuation from sales Order to Financial Accounting Master Data outbound process agent 936 to invoke the Request Product Valuation operation 959. The operation 959 is included in the Product and Resource Valuation Out interface 961. The operation 959 can update the Financial Accounting Master Data Management process component 526 about the product valuation request.

The Sales Order business object 144 can also use a synchronous Request Credit Worthiness from Sales Order to Credit Management outbound process agent 970 to invoke the Request Credit Worthiness operation 972. The operation 970 is included in the Credit Usage Out interface 972. The operation 970 can update the Credit Management process component 259 about the credit worthiness request.

As shown in FIG. 9C, the Sales Order business object 144 can use a Request Invoicing from Sales Order to Customer Invoice Processing asynchronous outbound process agent 937 to invoke a Request Invoicing operation 938. The Request Invoicing operation 938 is included in a Request Invoicing Out interface 940 and can update the Customer Invoice Processing process component 104.

The Sales Order business object 144 can also use a Request Requirement Reservation and Fulfillment from Sales Order to Customer Requirement asynchronous outbound process agent 942 to invoke a Request Product Customer Requirement Reservation and Fulfillment operation 944. The operation 944 is included in a Fulfillment Out interface 946 and can update the Customer Requirement Processing process component 502.

The Sales Order business object 144 can also use a Notify of Sales Order to Accounting asynchronous outbound process agent 948 to invoke a Notify of Sales Order operation 950. The Notify of Sales Order operation 950 is included in an Order Accounting Out interface 952 and can update the Accounting process component 204.

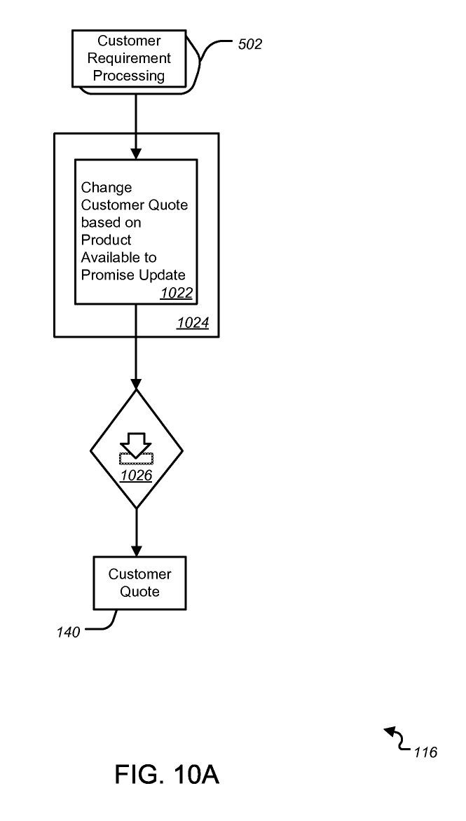

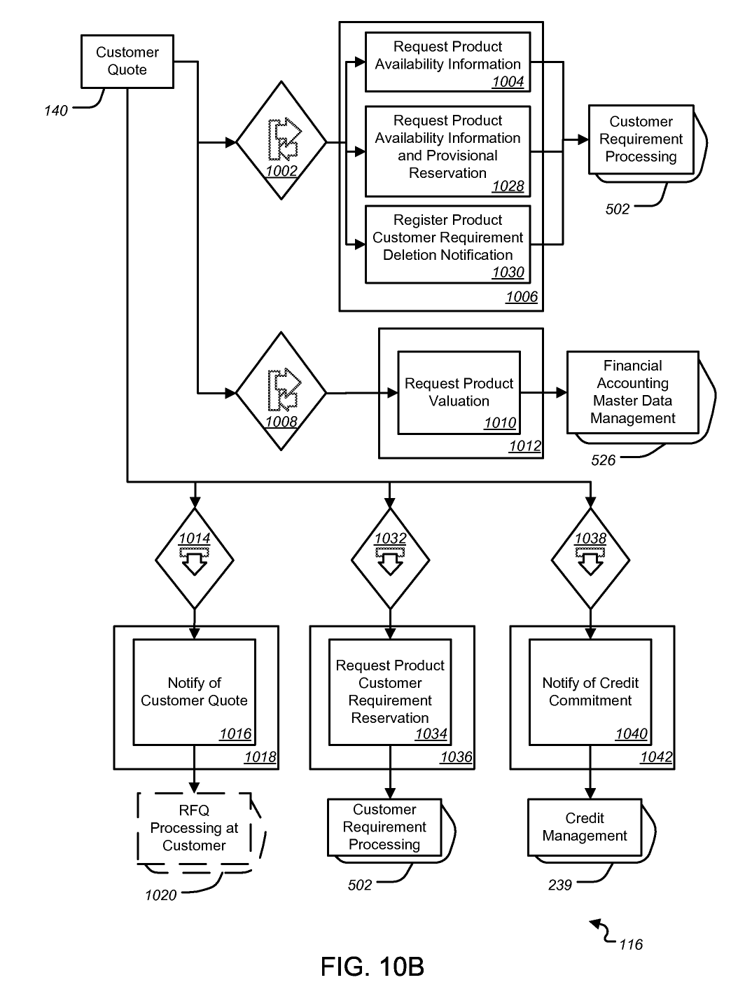

The Sales Order business object 144 can also use a Confirm Sales Order to Customer asynchronous outbound process agent 954 to invoke a Confirm Sales Order operation 956. The Confirm Sales Order operation 956 is included in an Ordering Out interface 958 and can update the Purchase Order Processing at Customer external process component 902. The Purchase Order Processing at Customer external process component 902 is drawn with dashed lines to indicate that it is used to represent an external system in describing interactions with the external system; this should be understood to require no more of the external system than that it be able to produce and receive messages as required by the process component that interacts with the external system. FIG. 10 is a block diagram showing a Customer Quote Processing process component 116. The Customer Quote Processing process component 116 handles processing of quotes to customers. In addition, the Customer Quote Processing process component 116 can be used to offer a customer delivery of goods or services according to specific terms. For convenience in describing this process component, a number of other process components are shown in the figures; these other process components are not part of the process component 116. These other process components are the Customer Requirement Processing process component 502, the Financial Accounting Master Data Management process component 526, and an RFQ Processing at Customer process component 1020. These other process components are used to represent software external to the process component 116 in describing its interactions with the external software; however, while the external software can be implemented as such process components, this is not required. The RFQ Processing at Customer process component 1020 is drawn with dashed lines to indicate that it is used to represent an external system in describing interactions with the external system; this should be understood to require no more of the external system than that it be able to produce and receive messages as required by the process component that interacts with the external system.

As shown in FIG. 9D, the Data Migration System process component 611 can invoke a Change Sales Order operation 962. The operation 962 updates the sales order based on changes from the purchase order. The operation 962 is included in a Ordering In interface 964. The operation 962 can use a Change Sales Order based on Data Migration asynchronous inbound process agent 966 to update the Sales Order business object 144.

A Customer Project Invoice Preparation process component 963 can invoke a Change Sales Order based on Customer Project Invoicing Agreement operation 968. The operation 968 is included in a Project Invoicing In interface 970. The operation 968 can use a Change Sales Order based on Invoicing Agreement asynchronous inbound process agent 972 to update the Sales Order business object 144.

The Sales Order business object 144 can use a Notify of Sales Order and Assignment to Project Processing asynchronous outbound process agent 972 to invoke a Notify of Sales Order and Assignment operation 974. The operation 974 is included in a Project Customer Transaction Document Assignment Out interface 976 and can update a Project Processing process component 965.

The Sales Order business object 144 can also use a Notify of Credit Commitment from Sales Order to Credit Management asynchronous outbound process agent 978 to invoke a Notify of Credit Commitment operation 980. The operation 980 is included in a Credit Usage Out interface 982 and can update the Credit Management process component 259.

The Sales Order business object 144 can also use a Request Invoicing from Sales Order to Customer Project Invoice Preparation asynchronous outbound process agent 984 to invoke a Request Customer Project Invoicing operation 986. The operation 986 is included in a Request Customer Project Invoicing Out interface 988 and can update a Customer Project Invoice Preparation process component 963.

FIGS. 10A and 10B are block diagrams collectively showing a Customer Quote Processing process component 116.

As shown in FIG. 10A, the Customer Requirement Processing process component 502 can update the Customer Quote business object 140. The Customer Requirement Processing process component 502 can invoke a Change Customer Quote based on Product Available to Promise Update operation 1022. The operation 1022 is included in a Fulfillment In interface 1024. The operation 1022 can use a Change Customer Quote based on Product Available to Promise Update asynchronous inbound process agent 1026 to update the Customer Complaint business object 140.

As shown in FIG. 10B, the Customer Quote business object 140 can use a synchronous Request Product Availability from Customer Quote to Customer Requirement inbound process agent 1002 to invoke a Request Product Availability Information operation 1004, a Request Product Availability Information and Provisional Reservation operation 1028, and/or a Register Product Customer Requirement Deletion Notification operation 1030. The Request Product Availability Information operation 1004 requests availability information including the creation of a provisional reservation for service order spare part items. The operations 1004, 1028, and 1030 are included in a Fulfillment Out interface 1006. The operations 1004, 1028, and 1030 can send an update to the Customer Requirement Processing process component 502.

The Customer Quote business object 140 can also use a Synchronous Request Product Valuation from Customer Quote to Customer Requirement outbound process agent 1008 to invoke a Request Product Valuation operation 1010. The Request Product Valuation operation 1010 requests a product valuation. The operation 1010 is included in a Product and Resource Valuation Out interface 1006. The operation 1010 can update the Financial Accounting Master Data Management process component 526 about the product valuation request.

The Customer Quote business object 140 can also use a Notify Customer of Customer Quote asynchronous outbound process agent 1014 to invoke a Notify of Customer Quote operation 1016. The Notify of Customer Quote operation 1016 notifies a customer about a customer quote. The Notify of Customer Quote operation 1016 is included in a Quote Processing Out interface 1018. The operation 1016 can update an RFQ Processing at Customer process component 1020.

The Customer Quote business object 140 can also use a Request Requirement Reservation from Customer Quote to Customer Requirement asynchronous outbound process agent 1032 to invoke a Request Product Customer Requirement Reservation operation 1034. The operation 1034 requests the reservation for a customer requirement. The operation 1034 is included in a Fulfillment Out interface 1036. The operation 1034 can update the Customer Requirement Processing process component 502.

The Customer Quote business object 140 can also use a Notify of Credit Commitment from Customer Quote to Credit Management asynchronous outbound process agent 1038 to invoke a Notify of Credit Commitment operation 1040. The operation 1040 provides invoice information necessary to update a credit commitment. The operation 1040 is included in a Credit Usage Out interface 1042. The operation 1040 can update the Credit Management process component 239.

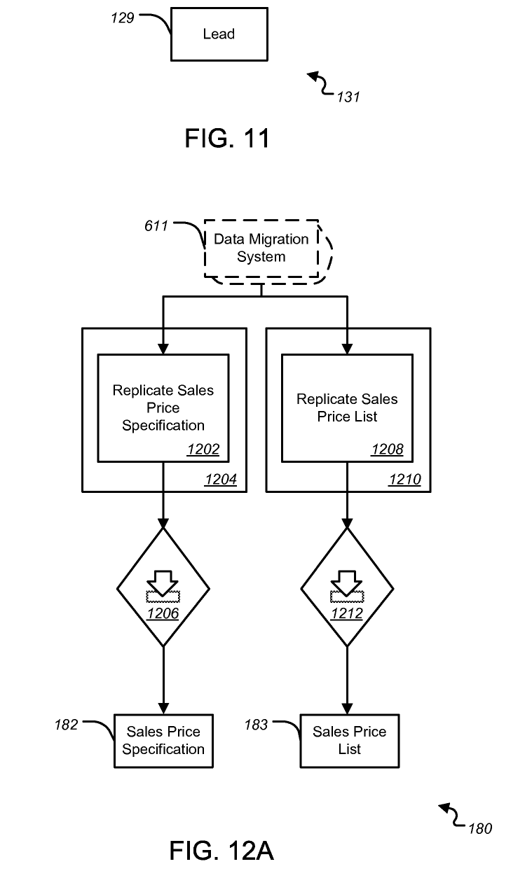

FIG. 11 is a block diagram showing a Lead Processing process component 131. The Lead Processing process component 131 handles the potential interest of a business partner and the interactions with him or her over a certain timeframe. The Lead Processing process component 131 includes the Lead business object 129. The Lead business object 129 represents a potential or projected business interest of a business partner and the interactions based on this, over a period of time.

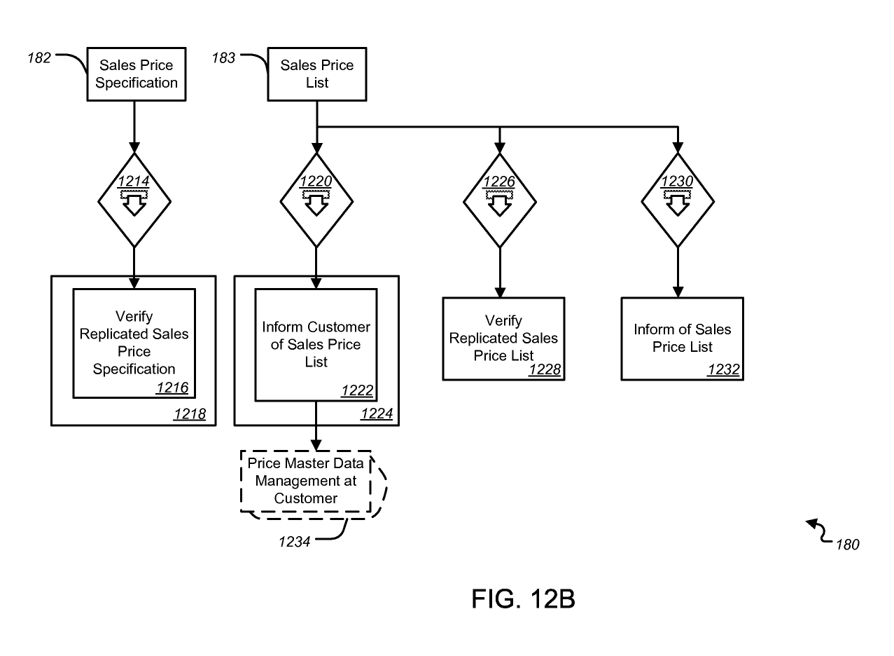

FIGS. 12A and 12B are block diagrams collectively showing a Price Master Data Management process component 180. The Price Master Data Management process component 180 manages prices and price-related data for sales and procurement processes. The Price Master Data Management process component 180 includes a Sales Price Specification business object 182 and a Sales Price List business object 183. The Sales Price Specification business object 182 represents a specification of a price, a discount, or a surcharge that is used indirectly using pricing in sales and service documents. The specification is defined for a combination of properties and is valid for a specific period. The Sales Price List business object 183 represents a list of price specifications with respect to common identifying criteria.

As shown in FIG. 12A, the Data Migration System process component 611 can update the Sales Price Specification business object 182 and the Sale Price List business object 183. The Data Migration System process component 611 can invoke a Replicate Sales Price Specification operation 1202. The operation 1202 is included in a Sales Price Specification Replication In interface 1204. The operation 1202 can use a Replicate Sales Price Specification asynchronous inbound process agent 1206 to update the Sales Price Specification business object 182.

The Data Migration System process component 611 can invoke a Replicate Sales Price List operation 1208. The operation 1202 is included in a Replication In interface 1210. The operation 1208 can use a Replicate Sale Price List asynchronous inbound process agent 1212 to update the Sale Price List business object 183.

As shown in FIG. 12B, the Sales Price Specification business object 182 can use a synchronous Verify Replicated Sales Price Specification outbound process agent 1214 to invoke a Verify Replicated Sales Price Specification operation 1216. The operation 1216 is included in a Sales Price Specification Information Out interface 1218.

The Sales Price List business object 183 can use a synchronous Inform of Sales Price List for Output outbound process agent 1220 to invoke an Inform Customer of Sales Price List operation 1222. The operation 1222 informs customers about sales price lists. The operation 1222 is included in a Sales Price List Information Out interface 1224. The operation 1222 can send an update to a Price Master Data Management process component 1234.

The Sales Price List business object 183 can also use a synchronous Verify Replicated Sales Price List outbound process agent 1226 to invoke a Verify Replicated Sales Price List operation 1228. The Sales Price List business object 183 can also use a synchronous Inform of Sales Price List for Output outbound process agent 1230 to invoke an Inform of Sales Price List operation 1232.

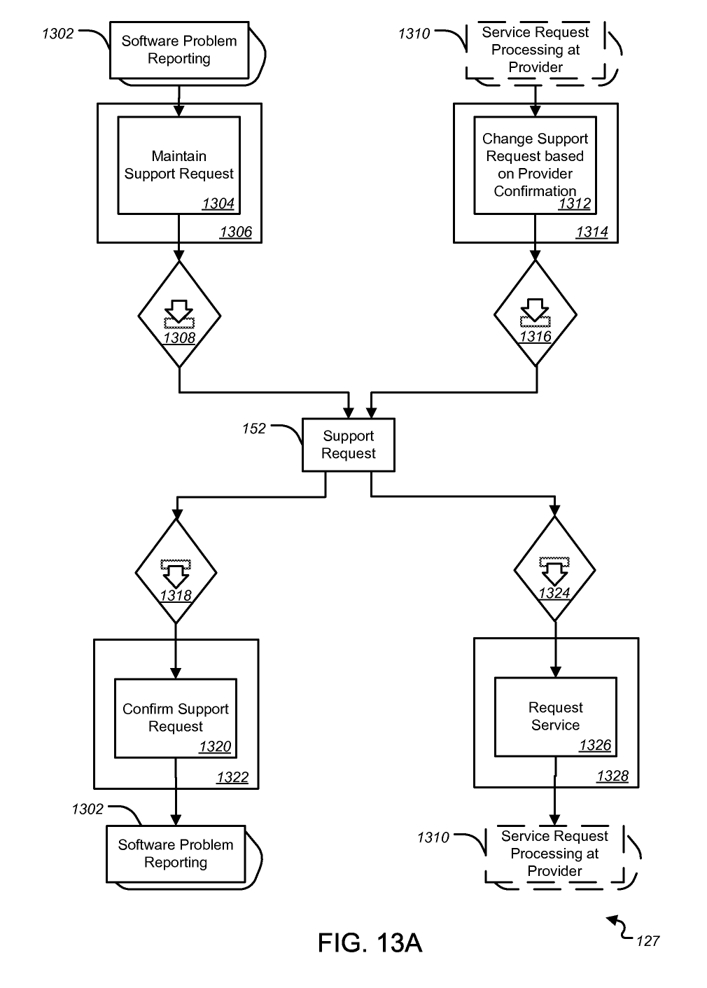

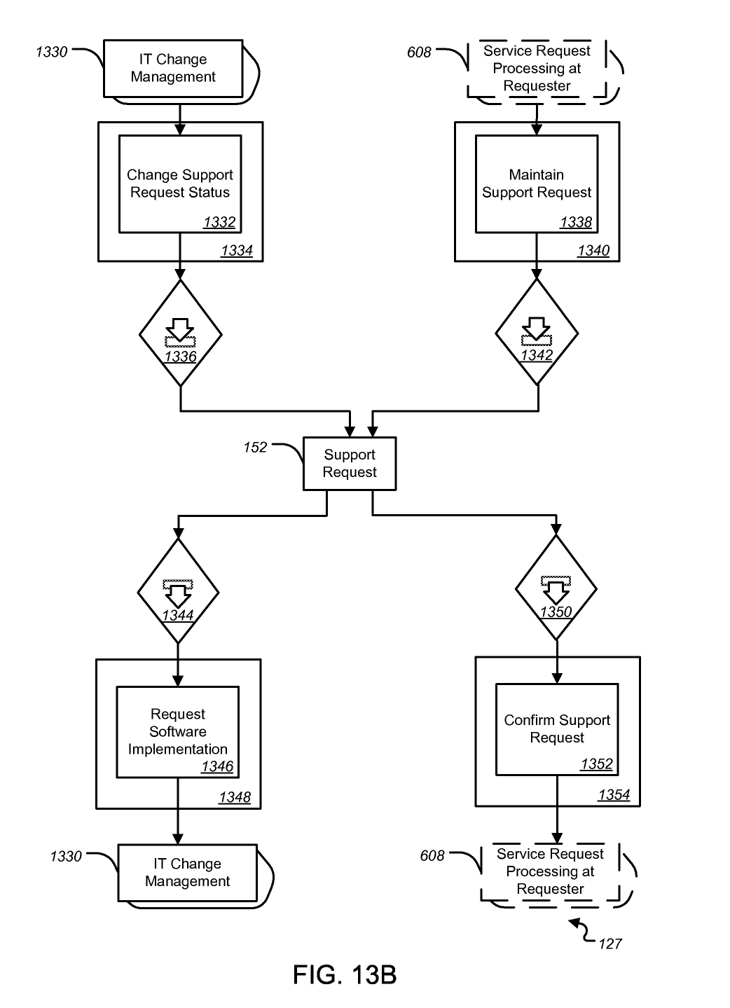

FIGS. 13A and 13B are block diagrams collectively showing a Support Request Processing process component 127. The Support Request Processing process component 127 can include a request reflecting an initial inquiry to clarify and solve an incident during operation of an IT system. The inquiry can be sent by a user of an IT system or by the system itself to an internal IT service desk. The inquiry can also include information on the user, the nature and context of the incident, or description of the symptom including, but not limited to classification, underlying problem, reason for service request, and meaning of the incident. The Support Request Processing process component 127 can ensure than an appropriate reaction, prioritization and scheduling is appropriately set.

For convenience in describing this process component, a number of other process components are shown in the figures; these other process components are not part of the process component 127. These other process components are a Software Problem Reporting process component 1302 and a Service Request Processing at Provider process component 1310. These other process components are used to represent software external to the process component 127 in describing its interactions with the external software; however, while the external software can be implemented as such process components, this is not required. The Service Request Processing at Provider process component 1310 is drawn with dashed lines to indicate that it is used to represent an external system in describing interactions with the external system; this should be understood to require no more of the external system than that it be able to produce and receive messages as required by the process component that interacts with the external system.

As shown in FIG. 13A, the Software Problem Reporting process component 1302 can send a message to a Service Request Processing at Provider process component 1310, which is handled by a Maintain Support Request operation 1304. The operation 1304 is included in a Software Problem Reporting In interface 1306. The Maintain Support Request operation 1304 can use a maintain Support Request asynchronous inbound process agent 1308 to update the Support Request business object 152.

The Service Request Processing at Provider process component 1310 can also update the Support Request business object 152 by sending a message to the Service Request Processing at Provider process component 1310, which is handled by a Change Support Request based on Provider Confirmation operation 1312. The operation 1312 is included in an External Requesting In interface 1314. The operation 1312 can use a Change Support Request based on Provider Confirmation asynchronous outbound process agent 1316 to update the Support Request business object 152.

Upon receiving an update, the Support Request business object 152 can confirm the request and request service. A Confirm Support Request from Support Request to Software Problem Reporting asynchronous outbound process agent 1318 can invoke a Confirm Support Request operation 1320. The operation 1320 is included in a Software Problem Reporting Out interface 1322. The operation 1320 can update the Software Problem Reporting process component 1302 about the confirmation. Similarly a Request Service from Support Request to Provider asynchronous outbound process agent 1324 can invoke a Request Service operation 1326. The operation 1326 is included in an External Requesting Out interface 1328. The operation 1326 can update the Service Request Processing at Provider 1310 about the requested service.

As shown in FIG. 13B, an IT Change Management process component 1330 can send a message to the Service Request Processing at Requestor process component 608 which is handled by a Change Support Request Status operation 1332. The operation 1332 is included in an Implementation In interface 1334. The Change Support Request Status operation 1332 can use a Change Support Request Status asynchronous inbound process agent 1336 to update the Support Request business object 152.

The Service Request Processing at Requestor process component 608 can also update the Support Request business object 152 by sending a message to the IT Change Management process component 1330, which is handled by a Maintain Support Request operation 1338. The operation 1338 is included in an External Providing In interface 1340. The operation 1338 can use a Maintain Support Request asynchronous outbound process agent 1342 to update the Support Request business object 152.

Upon receiving an update, the Support Request business object 152 can confirm the request and request service. A Request Implementation from IT Change Management asynchronous outbound process agent 1344 can invoke a Request Software Implementation operation 1346. The operation 1346 is included in an Implementation Out interface 1348. The operation 1346 can inform the IT Change Management process component 1330 about the request. Similarly a Confirm Support Request to External Requester asynchronous outbound process agent 1350 can invoke a Confirm Support Request operation 1352. The operation 1352 is included in an External Providing Out interface 1354. The operation 1352 can update the Service Request Processing at Requestor process component 608 about the requested service.

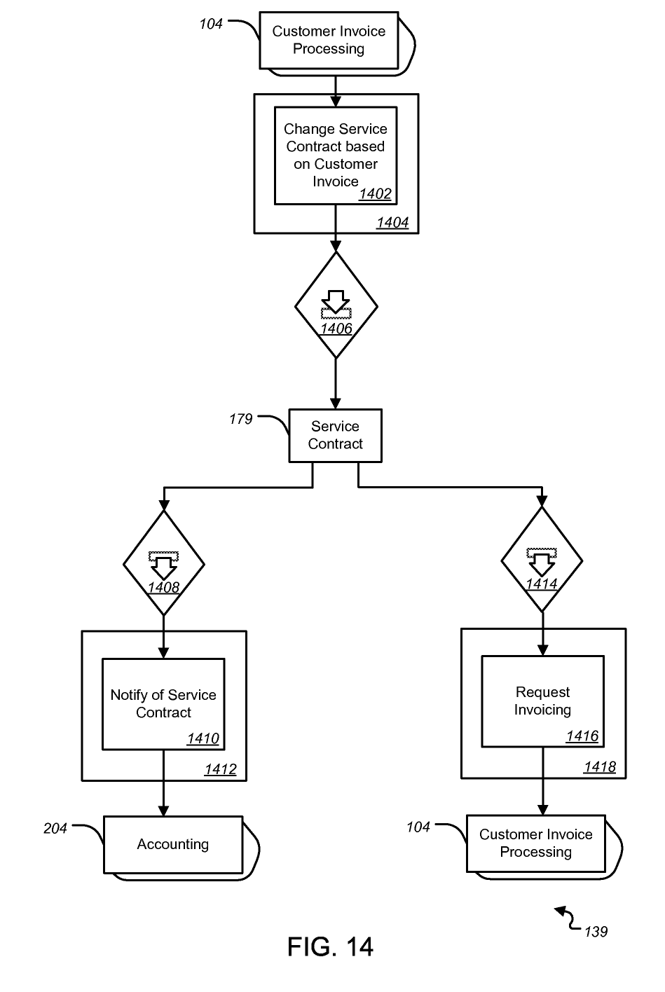

As shown in FIG. 14, the Customer Invoice Processing process component 104 can send a message to the Accounting process component 204 and the Customer Invoice Processing process component 104 which is handled by a Change Service Contract based on Customer Invoice operation 1402. The operation 1402 is included in a Request Invoicing In interface 1404. The Change Support Request Status operation 1402 can use a Change Service Contract based on Customer Invoice asynchronous inbound process agent 1406 to update the Service Contract business object 179.

Upon receiving an update, the Service Contract business object 179 can confirm the request and request service. A Notify of Service Contract to Accounting asynchronous outbound process agent 1408 can invoke a Notify of Service Contract operation 1410. The operation 1410 is included in a Sales and Purchasing Accounting Out interface 1412. The operation 1410 can update the Accounting process component 204 about the notification. Similarly a Request Invoicing from Service Contract to Customer Invoice Processing asynchronous outbound process agent 1414 can invoke a Request Invoicing operation 1416. The operation 1416 is included in a Request Invoicing Out interface 1418. The operation 1416 can update the Customer Invoice Processing process component 104 about the requested service.

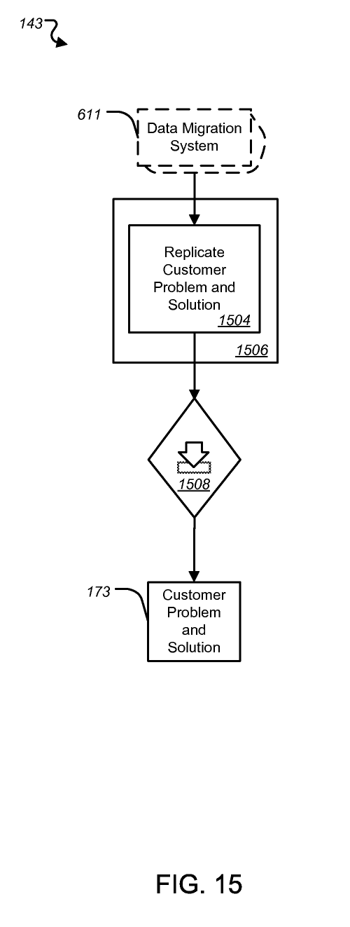

FIG. 15 is a block diagram showing a Customer Problem and Solution Administration process component 143. As shown in FIG. 15, the Data Migration System process component 611 can update the Customer Problem and Solution business object 173. The Data Migration System process component 611 can invoke a Replicate Customer Problem and Solution operation 1504. The operation 1504 is included in a Replication In interface 1506. The operation 1504 can use a Replicate Customer Problem and Solution asynchronous inbound process agent 1508 to update the Customer Problem and Solution business object 173.

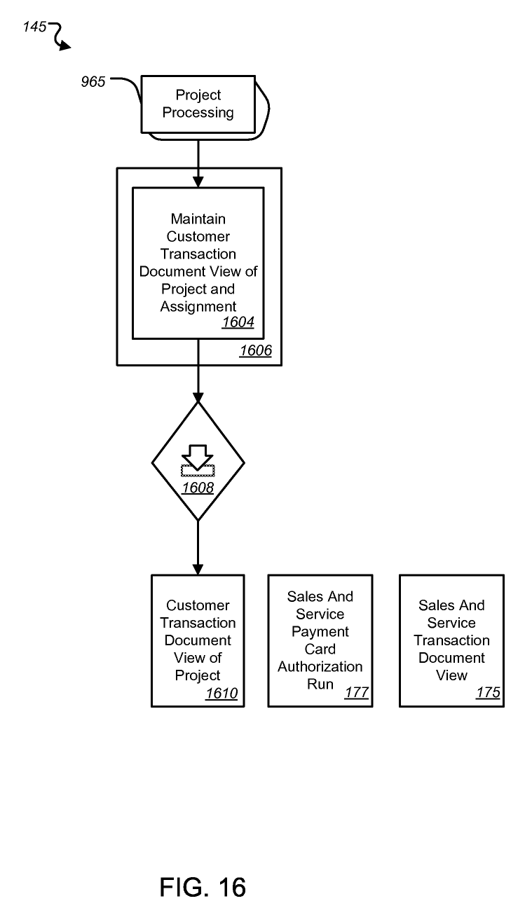

FIG. 16 is a block diagram showing a Customer Relationship Auxiliaries Processing process component 145. As shown in FIG. 16, the Project Processing process component 965 can update a Customer Transaction Document View of Project business object 1610. The Project Processing process component 965 can invoke a Maintain Customer Transaction Document View of Project and Assignment operation 1604. The operation 1604 is included in a Project Customer Transaction Document Assignment In interface 1606. The operation 1604 can use a Maintain Customer Transaction Document View of Project and Customer Transaction Document Assignment asynchronous inbound process agent 1608 to update the Customer Transaction Document View of Project business object 1610.

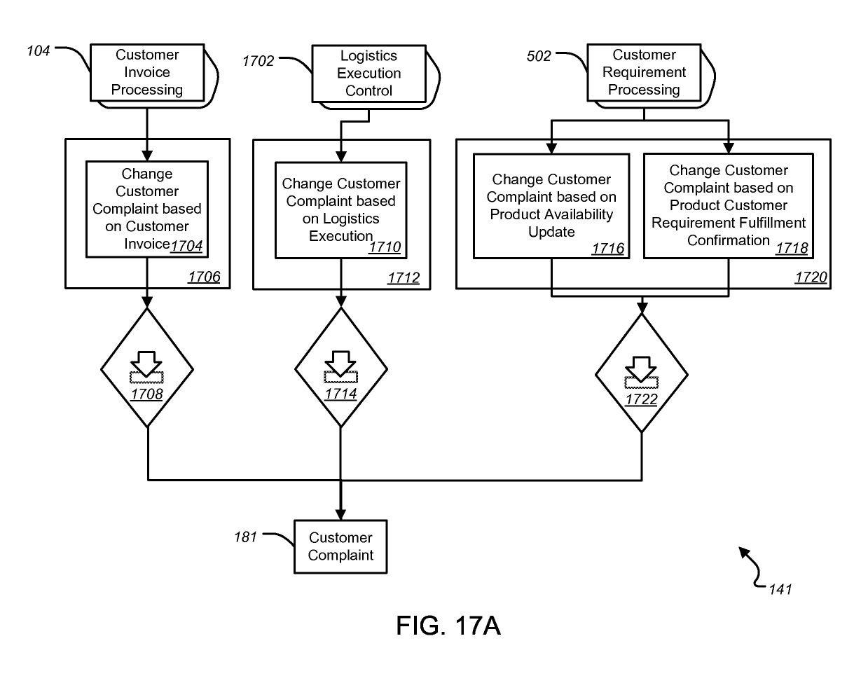

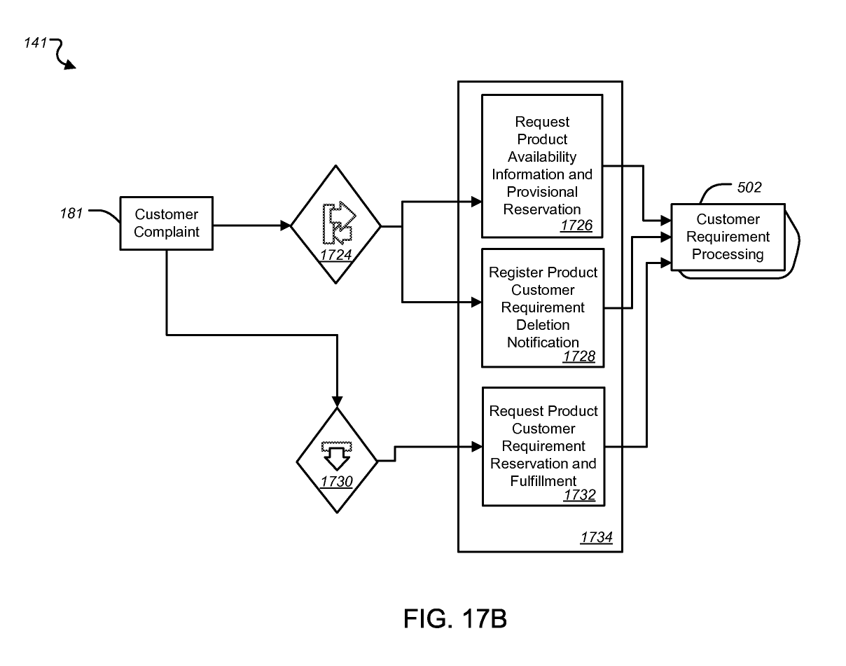

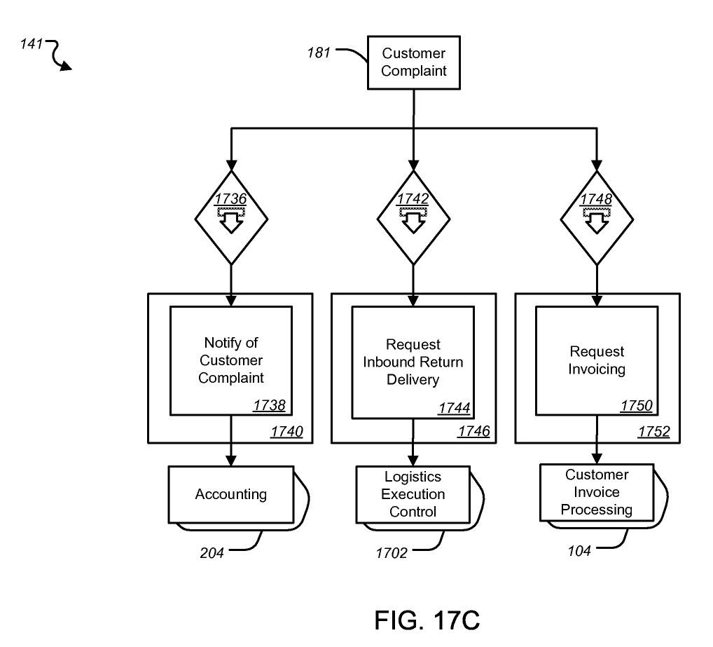

FIGS. 17A, 17B and 17C are block diagrams collectively showing a Customer Complaint Processing process component 141. As shown in FIG. 17A, the Customer Invoice Processing process component 104 can update the Customer Complaint business object 181. The Customer Invoice Processing process component 104 can invoke a Change Customer Complaint Based on Customer Invoice operation 1704. The operation 1704 is included in a Request Invoicing In interface 1706. The operation 1704 can use a Change Customer Complaint Based on Customer Invoice asynchronous inbound process agent 1708 to update the Customer Complaint business object 181.

A Logistics Execution Control process component 1702 can also update the Customer Complaint business object 181. The Logistics Execution Control process component 1702 can invoke a Change Customer Complaint Based on Logistics Execution operation 1710. The operation 1710 is included in a Request Inbound Delivering In interface 1712. The operation 1710 can use a Change Customer Complaint Based on Logistics Execution asynchronous inbound process agent 1714 to update the Customer Complaint business object 181.

The Customer Requirement Processing process component 502 can also update the Customer Complaint business object 181. The Customer Requirement Processing process component 502 can invoke a Change Customer Complaint Based on Product Availability Update operation 1716 or a Change Customer Complaint Based on Product Availability Update operation 1718. The operations 1716 and 1718 are included in a Fulfillment In interface 1720. The operations 1716 and 1718 can use a Change Customer Complaint based on Customer Requirement asynchronous inbound process agent 1722 to update the Customer Complaint business object 181.

As shown in FIG. 17B, after receiving an update, the Customer Complaint business object 181 can use a synchronous Request Availability Information and Reservation from Customer Complaint to Customer Requirement outbound process agent 1724 to invoke a Request Product Availability Information and Provisional Reservation operation 1726. The operation 1726 requests availability information including the creation of a provisional reservation for compensation delivery items. The business object 181 can also invoke a Register Product Customer Requirement Deletion Notification operation 1728. The operation 1728 registers provisional customer requirement reservation for deletion and triggers deletion in case of failure or cancellation of transaction processing. Both operations 1726,1728 are included in a Fulfillment Out interface 1734 and can update the Customer Requirement Processing process component 502.

The Customer Complaint business object 181 can also use an asynchronous Request Requirement Reservation and Fulfillment from Customer Complaint to Customer Requirement outbound process agent 1724 to invoke a Request Product Customer Requirement Reservation and Fulfillment operation 1726. The operations 1732 requests fulfillment planning and fulfillment execution for compensation delivery item. The operations 1732 is included in the Fulfillment Out interface 1734 and can update the Customer Requirement Processing process component 502.

As shown in FIG. 17C, the Customer Complaint business object 181 can also use a Notify of Customer Complaint from Customer Complaint to Accounting outbound process agent 1736 to invoke a Notify of Customer Complaint operation 1738. The operation 1738 is included in a Sales and Purchasing Accounting Out 1740 and can update the Accounting process component 204.

The Customer Complaint business object 181 can also use a Request Inbound Delivery Processing from Customer Complaint to Logistics Execution Control outbound process agent 1742 to invoke a Request Inbound Return Delivery operation 1744. The operation 1744 is included in a Request Inbound Delivering Out 1746 and can update a Logistics Execution Control process component 1702.

The Customer Complaint business object 181 can also use a Request Invoicing from Customer Complaint to Customer Invoice Processing outbound process agent 1748 to invoke a Request Invoicing operation 1750. The operation 1750 is included in a Request Invoicing Out 1752 and can update the Customer Invoice Processing process component 104.

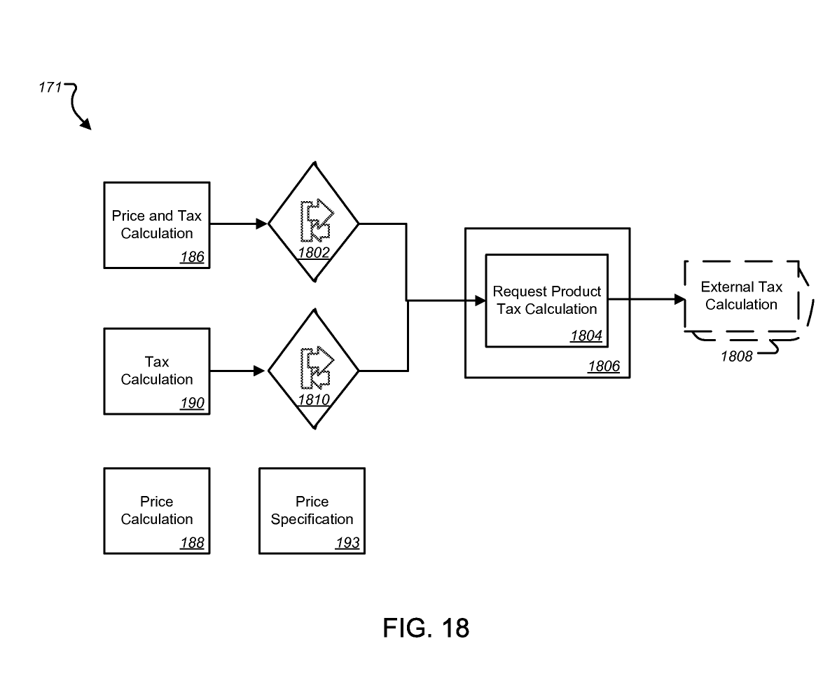

FIG. 18 is a block diagram showing the Pricing Engine process component 171. As shown in FIG. 18, the Price and Tax Calculation business object 186 can use a synchronous Request Product Tax Calculation from Price and Tax Calculation to External Tax Calculation outbound process agent 1802 to invoke a Request Product Tax Calculation operation 1804. The operation 1804 requests product tax calculations from an external tax calculation system. The operation 1804 is included in an External Tax Calculation Out interface 1806 and can update an External Tax Calculation process component 1808.

The Tax Calculation business object 190 can use a synchronous Request Product Tax Calculation from Tax Calculation to External Tax Calculation outbound process agent 1810 to invoke the Request Product Tax Calculation operation 1804.

The subject matter described in this specification and all of the functional operations described in this specification can be implemented in digital electronic circuitry, or in computer software, firmware, or hardware, including the structural means disclosed in this specification and structural equivalents thereof, or in combinations of them. The subject matter described in this specification can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described in this specification can be implemented in a computing system that includes a back-end component (e.g., a data server), a middleware component (e.g., an application server), or a front-end component (e.g., a client computer having a graphical user interface or a Web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the invention or of what may be claimed, but rather as illustrating preferred embodiments of the invention. Certain features that are described in this specification in the context of separate embodiments, may also be provided in combination in a single embodiment. Conversely, various features that are described in the context of a single embodiment may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter has been described in terms of particular variations, but other variations can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A computer readable medium including program code for providing message-based services using a service-oriented methodology for implementing an instance of a deployment unit, the medium comprising:
program code for storing an instance of a customer relationship management deployment unit for the management of all customer-related activities within marketing, presales, sales and service, including the recording and processing of all interactions throughout the entire customer life cycle, where the customer relationship management deployment unit defines the limits of an application-defined transaction for the management of all customer-related activities within marketing, presales, sales and service, including the recording and processing of all interactions throughout the entire customer life cycle by a set of actions that have atomicity, consistency, isolation, and durability in a database, and where the actions associated with the application-defined transaction are performed by one or more process components contained in the customer relationship management deployment unit, wherein each process component comprises a software package realizing a business process and exposing its functionality as one or more service operations, wherein the customer relationship management deployment unit comprises:
a campaign management process component;
a customer complaint processing process component, wherein the customer complaint processing process component implements the following service operations:
a request product availability info and provisional reservation operation, request product customer requirement reservation and fulfillment operation, a register product customer requirement deletion notification, a change customer complaint based on customer invoice operation, a notify of customer complaint operation, a change customer complaint based on product customer requirement fulfillment confirmation operation, a change customer complaint based on return delivery operation, a request invoicing operation, a change customer complaint based on product availability update operation, and a request inbound return delivery operation;
a customer problem and solution administration process component, wherein the customer problem and solution administration process component implements the following service operation:
a replicate customer problem and solution operation;
a customer quote processing process component, wherein the customer quote processing process component implements the following service operations:
a change customer quote based on product available to promise update operation, a request product availability information and provisional reservation operation, a request product availability information operation, a notify of credit commitment operation, a request product valuation operation, a request product customer requirement reservation operation, a request credit worthiness operation, a register product customer requirement deletion notification operation, and a notify of customer quote operation;
a customer relationship auxiliaries processing process component, wherein the customer relationship auxiliaries processing process component implements the following service operation:
a maintain CTD view of project and assignment operation;
a customer return processing process component, wherein the customer return processing process component implements the following service operations:
a notify of customer return operation, a read customer invoice operation, a maintain customer return based on inbound delivery operation, a change customer return based on customer invoice operation, and a request invoicing operation;
a lead processing process component;
an opportunity processing process component;
a sales order processing process component, wherein the sales order processing process component implements the following service operations:
a change sales order based on product availability update operation, a confirm sales order operation, a notify of credit commitment operation, a create sales order operation, a request invoicing operation, a request product customer requirement reservation and fulfillment operation, a request credit worthiness operation, a change sales order operation, a register product customer requirement deletion notification operation, a create sales order operation, a change sales order based on customer invoice operation, a notify of sales order operation, a change sales order based on product customer requirement fulfillment confirmation operation, a request product availability information and provisional reservation operation, a notify of sales order and assignment operation, a cancel sales order operation, and a request product valuation operation;
a support request processing process component, wherein the support request processing process component implements the following service operations:
a change support request based on provider confirmation operation, a confirm support request operation, a request service operation, a second confirm support request operation, a request software implementation operation, a change support request status operation, a maintain support request operation, and a second maintain support request operation;
a service confirmation processing process component, wherein the service confirmation processing process component implements the following service operations:
a financial expense notification out operation, a change service confirmation based on customer invoice operation, a notify of service confirmation operation, a request invoicing operation, a notify of spare part consumption operation, and a notify of spare part consumption cancellation operation;
a service contract processing process component, wherein the service contract processing process component implements the following service operations:
a notify of service contract operation, a request invoicing operation, and a change service contract based on customer invoice operation;
a service order processing process component, wherein the service order processing process component implements the following service operations:
a register product customer requirement deletion notification operation, a notify of service order operation, a confirm service order operation, a request product availability information and provisional reservation operation, a request invoicing operation, a request product customer requirement reservation and fulfillment operation, a change service order based on product customer requirement fulfillment confirmation operation, a change service order based on customer invoice operation, a change service order based on product availability update operation, a notify of service order credit commitment operation, a request product valuation operation, and request credit limit check operation; and
a service request processing process component, wherein the service request processing process component implements the following service operations:
a create service request operation, a notify of service provision operation, a notify of service provision cancellation operation, a notify of service request operation, a confirm service request operation, a change service request based on provider confirmation operation, a maintain service request operation, a request service operation, a request invoicing operation, and a change service request based on customer invoice operation;
wherein the process components of the customer relationship management deployment unit are packaged together to be deployed on a single computer system;
program code for executing the application-defined transaction for the management of all customer-related activities within marketing, presales, sales and service, including the recording and processing of all interactions throughout the entire customer life cycle; and
program code for presenting data associated with the executed application-defined transaction for the management of all customer-related activities within marketing, presales, sales and service, including the recording and processing of all interactions throughout the entire customer life cycle to a graphical user interface.

2. The medium of claim 1, wherein the campaign management process component comprises a target group business object and a target group marketing activity creation run business object.

3. The medium of claim 1, wherein the customer complaint processing process component comprises a customer complaint business object.

4. The medium of claim 1, wherein the customer problem and solution administration process component comprises a customer problem and solution business object.

5. The medium of claim 1, wherein the customer quote processing process component comprises a customer quote business object.

6. The medium of claim 1, wherein the customer relationship auxiliaries processing process component comprises a sales business object and service payment card authorization run, and a sales and service transaction document view business object.

7. The medium of claim 1, wherein the customer return processing process component comprises a customer return business object.

8. The medium of claim 1, wherein the lead processing process component comprises a lead business object.

9. The medium of claim 1, wherein the opportunity processing process component comprises an opportunity business object.

10. The medium of claim 1, wherein the sales order processing process component comprises a sales order business object.

11. The medium of claim 1, wherein the support request processing process component comprises a support request business object.

12. The medium of claim 1, wherein the service confirmation processing process component comprises a service confirmation business object.

13. The medium of claim 1, wherein the service contract processing process component comprises a service contract business object.

14. The medium of claim 1, wherein the service order processing process component comprises a service order business object.

15. The medium of claim 1, wherein the service request processing process component comprises a service request business object.

16. The medium of claim 1, wherein the services operations associated with the customer complaint processing process component are grouped into service interfaces, the service interfaces comprising:
a fulfillment in interface that includes the change customer complaint based on product customer requirement fulfillment confirmation, and change customer complaint based on product availability update operations;
a fulfillment out interface that includes the request product availability information and provisional reservation, request product customer requirement reservation and fulfillment, and register product customer requirement deletion notification operations;
a request invoicing in interface that includes the change customer complaint based on customer invoice operation;
a request invoicing out interface that includes the request invoicing operation; and
a sales and purchasing accounting out interface that includes the notify of customer complaint operation.

17. The medium of claim 1, wherein the services operations associated with the customer problem and solution administration process component are grouped into service interfaces, the service interfaces comprising:
a replication in interface that includes the replicate customer problem and solution operation.

18. The medium of claim 1, wherein the services operations associated with the customer quote processing process component are grouped into service interfaces, the service interfaces comprising:
a credit usage out interface that includes the notify of credit commitment and request credit worthiness operations; a fulfillment in interface that includes the change customer quote based on product available to promise update operation;
a fulfillment out interface that includes the request product availability information and provisional reservation, request product availability information, request product customer requirement reservation, and register product customer requirement deletion notification operations;
a product and resource valuation out interface that includes the request product valuation operation; and
a quote processing out interface that includes the notify of customer quote operation.

19. The medium of claim 1, wherein the services operations associated with the customer relationship auxiliaries processing process component are grouped into service interfaces, the service interfaces comprising:
a project customer transaction document assignment in interface that includes the maintain CTD view of project and assignment operation.

20. The medium of claim 1, wherein the services operations associated with the customer return processing process component are grouped into service interfaces, the service interfaces comprising:
a manage customer invoice out interface that includes the read customer invoice operation;
a request customer return execution in interface that includes the maintain customer return based on inbound delivery operation; a request invoicing in interface that includes the change customer return based on customer invoice operation;
a request invoicing out interface that includes the request invoicing operation; and
a sales and purchasing accounting out interface that includes the notify of customer return operation.

21. The medium of claim 1, wherein the services operations associated with the sales order processing process component are grouped into service interfaces, the service interfaces comprising:
a credit usage out interface that includes the notify of credit commitment, and request credit worthiness operations;
a fulfillment in interface that includes the change sales order based on product availability update, and change sales order based on product customer requirement fulfillment confirmation operations;
a fulfillment out interface that includes the request product customer requirement reservation and fulfillment, register product customer requirement deletion notification, and request product availability information and provisional reservation operations;
a migration in interface that includes the create sales order operation;
an ordering in interface that includes the change sales order, create sales order, and cancel sales order operations;
an ordering out interface that includes the confirm sales order operation;
a product and resource valuation out interface that includes the request product valuation operation;
a project customer transaction document assignment out interface that includes the notify of sales order and assignment operation;
a request invoicing in interface that includes the change sales order based on customer invoice operation;
a request invoicing out interface that includes the request invoicing operation; and
a sales and purchasing accounting out interface that includes the notify of sales order operation.

22. The medium of claim 1, wherein the services operations associated with the support request processing process component are grouped into service interfaces, the service interfaces comprising:
an external providing in interface that includes the maintain support request operation;
an external providing out interface that includes the confirm support request operation;
an external requesting in interface that includes the change support request based on provider confirmation operation;
an external requesting out interface that includes the request service operation;
an implementation in interface that includes the change support request status operation;
an implementation out interface that includes the request software implementation operation;
a software problem reporting in interface that includes the second maintain support request operation; and
a software problem reporting out interface that includes the second confirm support request operation.

23. The medium of claim 1, wherein the services operations associated with the service confirmation processing process component are grouped into service interfaces, the service interfaces comprising:
an inventory changing out interface that includes the notify of spare part consumption, and notify of spare part consumption cancellation operations;
a request invoicing in interface that includes the change service confirmation based on customer invoice operation;
a request invoicing out interface that includes the request invoicing operation; and
a sales and purchasing accounting out interface that includes the notify of service confirmation operation.

24. The medium of claim 1, wherein the services operations associated with the service contract processing process component are grouped into service interfaces, the service interfaces comprising:
a request invoicing in interface that includes the change service contract based on customer invoice operation;
a request invoicing out interface that includes the request invoicing operation; and
a sales and purchasing accounting out interface that includes the notify of service contract operation.

25. The medium of claim 1, wherein the services operations associated with the service order processing process component are grouped into service interfaces, the service interfaces comprising:
a fulfillment in interface that includes the change service order based on product customer requirement fulfillment confirmation, and change service order based on product availability update operations;
a fulfillment out interface that includes the register product customer requirement deletion notification, request product availability information and provisional reservation, and request product customer requirement reservation and fulfillment operations;
an ordering out interface that includes the confirm service order operation;
a product and resource valuation out interface that includes the request product valuation operation;
a request invoicing in interface that includes the change service order based on customer invoice operation;
a request invoicing out interface that includes the request invoicing operation; and
a sales and purchasing accounting out interface that includes the notify of service order operation.

26. The medium of claim 1, wherein the services operations associated with the service request processing process component are grouped into service interfaces, the service interfaces comprising:
an external providing in interface that includes the maintain service request operation;
an external providing out interface that includes the confirm service request operation;
an external requesting in interface that includes the change service request based on provider confirmation operation;
an external requesting out interface that includes the request service operation;
a migration in interface that includes the create service request operation;
a request invoicing in interface that includes the change service request based on customer invoice operation;
a request invoicing out interface that includes the request invoicing operation;
a sales and purchasing accounting out interface that includes the notify of service request operation; and
a service provision accounting out interface that includes the notify of service provision, and notify of service provision cancellation operations.

27. The medium of claim 1, wherein the single computer system comprises a single physical hardware platform.
